(19) United States
(12) Patent Application Publication
(10) Pub. No.: US 2024/0214926 A1
(43) Pub. Date: Jun. 27, 2024

(54) METHODS FOR INTER-NODE COORDINATION FOR RAN ENERGY SAVING

(71) Applicant: Telefonaktiebolaget LM Ericsson (publ), Stockholm (SE)

(72) Inventors: Reem KARAKI, AACHEN (DE); Angelo CENTONZA, GRANADA (ES); Henrik RYDÉN, STOCKHOLM (SE); Luca LUNARDI, GENOVA (IT); Pablo SOLDATI, SOLNA (SE)

(73) Assignee: Telefonaktiebolaget LM Ericsson (publ), Stockholm (SE)

(21) Appl. No.: 18/288,485

(22) PCT Filed: Apr. 27, 2022
(86) PCT No.: PCT/EP2022/061206

§ 371 Date: Oct. 26, 2023

Related U.S. Application Data
(60) Provisional application No. 63/181,993, filed on Apr. 30, 2021.
(60) Provisional application No. 63/182,018, filed on Apr. 30, 2021.

(51) Int. Cl. H04W 52/02

(52) U.S. Cl. CPC H04W 52/0206

(57) ABSTRACT

A method (600) performed by a first network node (100A, 800) for coordinating with a second network node (100B, 800) with respect to an energy metric. The method includes the first network node determining or identifying (s602) based on the energy metric at least one of: (i) an action to perform or (ii) a request relating to the second network node. The method also includes the first network node generating (s604) a first message, the first message comprising an indication that the action or the request is due to an energy saving reason. The method further includes the first network node transmitting (s606) the first message towards the second network node.

### TECHNICAL FIELD

Disclosed are embodiments related to coordination between network nodes to enable RAN level energy savings. New signaling procedures are introduced between network nodes that can be used to improve the network level energy consumption by enabling coordination between RAN nodes to consider the energy consumption implication of RAN actions on other RAN nodes.

### BACKGROUND

3GPP has specified the Long Term Evolution (LTE) Evolved Universal Terrestrial Radio Access Network (E-UTRAN) architecture. LTE E-UTRAN comprises base stations, which are referred to as “evolvedNodeBs (eNBs),” Mobility Management Entities (MMEs), and System Architecture Evolution Gateways (S-GWs). An S1 interface connects the eNBs to the MME/S-GW, and connectivity between eNBs is supported by an X2 interface.

The current fifth generation (5G) RAN (NG-RAN) (which is also referred to as New Radio (NR)) architecture is illustrated in FIG. 1 and described in 3GPP Technical Specification (TS) 38.401v15.4.0. The NG-RAN architecture can be further described as follows. The NG-RAN includes of a set of base stations 100A and 100B that are called “gNBs,” and the gNBs are connected to the 5G Core Network (5GC) 110 through the NG interface. A gNB 100A can be connected to another gNB 100B through the Xn interface. An gNB can support FDD mode, TDD mode or dual mode operation. gNBs can be interconnected through the Xn interface. A gNB may consist of a gNB central unit (gnB-CU) and one or more gNB distributed units (gnB-DUs). A gNB-CU and a gNB-DU are connected via the F1 logical interface. For resiliency, a gNB-DU may be connected to multiple gNB-CU by appropriate implementation. The NG interface, the Xn interface, and the F1 interface are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signalling transport.

A gNB may also be connected to an eNB via the X2 interface. Another architectural option is that where an eNB connected to an Evolved Packet Core (EPC) network is connected over the X2 interface with a so called nr-gNB. The latter is a gNB not connected directly to a core network (CN) and connected via X2 to an eNB for the sole purpose of performing dual connectivity.

The architecture in FIG. 1 can be expanded by spitting the gNB-CU into two entities. One gNB-CU-UP, which serves the user plane (UP) and hosts the Packet Data Convergence Protocol (PDCP) protocol and one gNB-CU-CP, which serves the control plane (CP) and hosts the PDCP and Radio Resource Control (RRC) protocol. A gNB-DU also hosts lower layer protocols.

### Energy Savings in LTE and NR Systems

It is advantageous to reduce the operational cost of the RAN through energy savings. This can be achieved by, among other things, turning on/off capacity cells to lower the energy consumption. The decision is typically based on cell load information. The decision can be taken by a RAN node (e.g., base station) or also by an Operation and Maintenance (O&M) function.

A gNB serving a cell that the gNB has deactivated in order to reduce energy consumption can inform a neighboring node of the deactivation by means of an NG-RAN node Configuration Update procedure over the Xn interface, as illustrated in FIG. 1 and described in 3GPP TS 38.423 v16.5.0. Additionally, a gNB node can request another gNB to switch on/off a cell by means of Cell Activation procedure over Xn interface.

Additionally, a RAN node may take energy efficiency actions by reducing load in its served cells. Such reduction in load may translate into reducing the number of served user equipments (UEs) or the number of bearers, and, therefore it may enable the activation of idle periods in the usage of certain functions, such reduction in use consequently generating a saving in energy consumption.

### NG-RAN Node Configuration Update

FIG. 2 is a signaling diagram showing a NG-RAN node Configuration Update procedure. One purpose of the NG-RAN node Configuration Update procedure is to update application level configuration data needed for two NG-RAN nodes to interoperate correctly over the Xn-C interface. The NG-RAN node Configuration Update message 201 is sent by a NG-RAN node to a neighboring NG-RAN node to transfer updated information for an Xn-C interface instance. The NG-RAN node Configuration Update Acknowledge message 203 is sent by the neighboring NG-RAN node back to the NG-RAN node.

TABLE 1
Configuration Update Message

| | | | IE type | | | |
|---|---|---|---|---|---|---|
| IE/Group | | | and | Semantics | | Assigned |
| Name | Presence | Range | reference | description | Criticality | Criticality |
| Message | M | | 9.2.3.1 | | YES | reject |
| Type | | | | | | |
| TAI Support | O | | 9.2.3.20 | List of | GLOBAL | reject |
| List | | | | supported | | |
| | | | | TAs and | | |
| | | | | associated | | |
| | | | | characteristics. | | |
| CHOICE | M | | | | YES | ignore |
| Initiating | | | | | | |
| NodeType | | | | | | |
| >gNB | | | | | | |
| >>Served | O | | 9.2.2.15 | | YES | ignore |
| Cells To | | | | | | |
| Update NR | | | | | | |
| >>Cell | O | | 9.2.2.17 | | YES | ignore |
| Assistance | | | | | | |
| Information | | | | | | |
| NR | | | | | | |
| >>Cell | O | | 9.2.2.43 | | YES | ignore |
| Assistance | | | | | | |
| Information | | | | | | |
| E-UTRA | | | | | | |
| >ng-eNB | | | | | | |
| >>Served | O | | 9.2.2.16 | | YES | ignore |
| Cells to | | | | | | |
| Update E- | | | | | | |
| UTRA | | | | | | |
| >>Cell | O | | 9.2.2.17 | | YES | ignore |
| Assistance | | | | | | |
| Information | | | | | | |
| NR | | | | | | |
| >>Cell | O | | 9.2.2.43 | | YES | ignore |
| Assistance | | | | | | |
| Information | | | | | | |
| E-UTRA | | | | | | |
| TNLA To | | 0 . . . 1 | | | YES | ignore |
| Add List | | | | | | |
| >TNLA To | | 1 . . . < maxnoofTNLAssociations> | | | — | |
| Add Item | | | | | | |
| >>TNLA | M | | CP | CP Transport | — | |
| Transport | | | Transport | Layer | | |
| Layer | | | Layer | Information of | | |
| Information | | | Information | NG-RAN | | |
| | | | 9.2.3.31 | node₁ | | |
| >> TNL | M | | 9.2.3.84 | | — | |
| Association | | | | | | |
| Usage | | | | | | |
| TNLA To | | 0 . . . 1 | | | YES | ignore |
| Update List | | | | | | |
| >TNLA To | | 1 . . . < maxnoofTNLAssociations> | | | — | |
| Update | | | | | | |
| Item | | | | | | |
| >>TNLA | M | | CP | CP Transport | — | |
| Transport | | | Transport | Layer | | |
| Layer | | | Layer | Information of | | |
| Information | | | Information | NG-RAN | | |
| | | | 9.2.3.31 | node₁ | | |
| >> TNL | O | | 9.2.3.84 | | — | |
| Association | | | | | | |
| Usage | | | | | | |
| TNLA To | | 0 . . . 1 | | | YES | ignore |
| Remove | | | | | | |
| List | | | | | | |
| >TNLA To | | 1 . . . < maxnoofTNLAssociations> | | | — | |
| Remove | | | | | | |
| Item | | | | | | |
| >>TNLA | M | | CP | CP Transport | — | |
| Transport | | | Transport | Layer | | |
| Layer | | | Layer | Information of | | |
| Information | | | Information | NG-RAN | | |
| | | | 9.2.3.31 | node₁ | | |
| Global NG- | O | | 9.2.2.3 | | YES | reject |
| RAN Node | | | | | | |
| ID | | | | | | |
| AMF Region | O | | AMF | List of all | YES | reject |
| Information | | | Region | added AMF | | |
| To Add | | | Information | Regions to | | |
| | | | 9.2.3.83 | which the NG- | | |
| | | | | RAN node | | |
| | | | | belongs. | | |
| AMF Region | O | | AMF | List of all | YES | reject |
| Information | | | Region | deleted AMF | | |
| To Delete | | | Information | Regions to | | |
| | | | 9.2.3.83 | which the NG- | | |
| | | | | RAN node | | |
| | | | | belongs. | | |
| Interface | O | | 9.2.2.39 | | YES | reject |
| Instance | | | | | | |
| Indication | | | | | | |
| TNL | O | | 9.2.3.96 | | YES | ignore |
| Configuration | | | | | | |
| Info | | | | | | |

As shown in Table 2 below, the Served Cells To Update NR IE contains updated configuration information for served NR cells exchanged between NG-RAN nodes.

TABLE 2

| IE/Group | | | IE type and | Semantics | Criticality | Assigned |
|---|---|---|---|---|---|---|
| Name | Presence | Range | reference | description | | Criticality |
| Served Cells | | 0 . . . <maxnoofCellsinNG- | | List of added | GLOBAL | reject |
| NR To Add | | RAN node> | | cells served by | | |
| | | | | the NG-RAN | | |
| | | | | node. | | |
| >Served Cell | M | | 9.2.2.11 | | — | |
| Information | | | | | | |
| NR | | | | | | |
| >Neighbour | O | | 9.2.2.13 | | — | |
| Information | | | | | | |
| NR | | | | | | |
| >Neighbour | O | | 9.2.2.14 | | — | |
| Information | | | | | | |
| E-UTRA | | | | | | |
| Served Cells | | 0 . . . <maxnoofCellsinNG- | | List of modified | YES | reject |
| To Modify NR | | RAN node> | | cells served by | | |
| | | | | the NG-RAN | | |
| | | | | node. | | |
| >Old NR CGI | M | | NR CGI | | — | |
| | | | 9.2.2.7 | | | |
| >Served Cell | M | | 9.2.2.11 | | — | |
| Information | | | | | | |
| NR | | | | | | |
| >Neighbour | O | | 9.2.2.13 | | — | |
| Information | | | | | | |
| NR | | | | | | |
| >Neighbour | O | | 9.2.2.14 | | — | |
| Information E- | | | | | | |
| UTRA | | | | | | |
| >Deactivation | O | | ENUMERATED | Indicates that | — | reject |
| Indication | | | (deactivated, . . . ) | the concerned | | |
| | | | | cell is switched | | |
| | | | | off for energy | | |
| | | | | saving | | |
| | | | | reasons. | | |
| Served Cells | | 0 . . . <maxnooffCellsinNG- | | List of deleted | YES | |
| To Delete NR | | RAN node > | | cells served by | | |
| | | | | the NG-RAN | | |
| | | | | node. | | |
| >Old NR-CGI | M | | NR CGI | | — | |
| | | | 9.2.2.7 | | | |

FIG. 3 is a signaling diagram illustrating a Cell Activation procedure. One purpose of the Cell Activation procedure is to enable an NG-RAN node to request a neighbouring NG-RAN node to switch on one or more cells, previously reported as inactive due to energy saving.

The NG-RAN node1 initiates the procedure by sending the CELL ACTIVATION REQUEST message 301 to the peer NG-RAN node2.

Upon reception of this message, the NG-RAN node2 should activate the cell/s indicated in the CELL ACTIVATION REQUEST message and shall indicate in the CELL ACTIVATION RESPONSE message 303 for which cells the request was fulfilled.

### SUMMARY

Certain challenges presently exist due to the increase in data traffic. One attractive solution to cope with the increase in data traffic is densification either by adding more Macro cells or small cells complementing the macro layer. Generally, Mobile networks can be designed according to performance requirements which, possibly for a large percentage of their operation time, result in resource overprovisioning. However, this extreme capacity is not needed all the time since traffic varies. From both cost and energy consumption point of view, this is not optimal if the additional cells or layers are operating all the time.

Current NR design includes the support of basic energy saving features. A gNB can turn on/off capacity cells to lower the energy consumption. However, currently the gNB autonomously performs the decision without knowledge of the implications of this decision on neighboring nodes, and without taking into consideration the implications of the decision on the overall network energy consumption. The situation can get even worse if neighboring nodes take conflicting decisions. For example, a gNB autonomously deactivating cells for which it will need to move traffic to neighbor nodes, while a neighbor gNB may perform Energy Efficiency (EE) decisions by reducing load (shifting load to neighbors).

The current inter-node signaling does not provide enough information about the neighboring nodes to be able to derive the implications of the EE decision on neighboring nodes. For instance, current NR signaling includes the support of load/capacity information exchange between different gNBs over Xn. This information alone is not enough to derive the implications of EE decisions (such as traffic steering to that node) on the energy consumption of the neighboring node since the energy consumption is highly dependent on the gNB implementation and capabilities.

Currently a source RAN node may initiate a handover due to load. This mainly serves the case when the source node is overloaded or a more even distribution of traffic is desired between nodes, and the source node determines to offload some of its traffic. From energy saving perspective, in certain cases (e.g. low traffic load) it is also beneficial to move users to a neighboring node, so to increase the possibility and/or duration of periods during which energy saving can be achieved (e.g. the activity or intensity of energy-demanding RAN functions that be reduced).

The implications of those causes on the network or the importance of each of those causes is very different. For instance, a handover (HO) due to load is mainly striving to improve end user performances. On the other hand, a HO due to Energy saving is mainly trying to reach/improve energy efficiency targets at the network or operator side. Therefore, it is important that the target RAN knows the exact cause of an incoming HO so that it is able to apply appropriate admission control and prioritization of different requests.

A source RAN node can also control the load by adjusting mobility parameters for at least one of its cells (or beams) as well as requesting (or suggesting) mobility parameter to be used at target cells (or beams) served by a target RAN node. For example, a HO action can be triggered earlier in some cases, or even delayed in other cases. In that sense, adjusting the mobility parameters can impact the energy consumption of a cell. For example, a source RAN node wishing to maintain a low energy consumption for one of its cells (or reduce the energy consumption for one of its cells), can request/suggest to a target RAN node adjustment of mobility thresholds between a cells of the source RAN node and neighboring cells served by the target RAN node, so that mobility of UEs from the neighboring cells is prevented, discouraged or only possible upon particular conditions (e.g. high traffic load), for a predetermined or configured time interval. However, since this can have negative impacts on the UE performance, it is beneficial to make the target cell aware that this request is performed due to a wish, or “nice to have” energy saving effect, or due to an urgent condition (e.g. indicated with a “congestion indication” cause).

Embodiments disclosed herein provide methods for coordination between network nodes to enable RAN level energy savings, wherein a first node and a second node can coordinate by indicating if an intended/performed action and/or a request is associated to energy saving. In this case, the message from the first RAN node to the second RAN node indicates that the intended/performed action and/or request is due to energy savings reasons. The message may optionally indicate additional information related to the energy consumption status of the first and/or Second RAN node

Additional signaling aspects disclosed herein include methods for acquiring information about the possibility for a network node of accepting an offloading request triggered by energy savings reasons in another network node. In this case, the first RAN node indicates the load information that it desires to offload to the second RAN node in order to reach a desirable energy consumption status at the first and/or second RAN node. In addition, methods are disclosed herein for exchanging and/or agreeing on a preferred energy efficiency policy or validity criteria to avoid contradicting energy saving decisions from different RAN nodes. In this case the policies can be configured by the RAN node, a management entity (e.g. OAM), or an external/third node.

The methods in here are applicable, but not limited to mobility scenarios, wherein improvements in the energy efficiency targets at the network can be achieved by triggering mobility actions. In such cases, first RAN node may trigger, e.g., handover of UE(s), or adjusting the mobility parameters towards a second RAN node with the aim of reaching a desirable energy consumption status at First and/or Second RAN node.

Accordingly, in one aspect there is provided a method performed by a first network node for coordinating with a second network node with respect to an energy metric. The method includes the first network node determining or identifying based on the energy metric at least one of: (i) an action to perform or (ii) a request relating to the second network node. The method includes the first network node generating a first message, the first message comprising an indication that the action or the request is due to an energy saving reason. The method includes the first network node transmitting the first message towards the second network node.

In another aspect, there is provided a method performed by a second network node for coordinating with a first network node with respect to an energy metric. The method includes the second network node receiving a first message transmitted by the first network node, the first message comprising a request comprising an indication that an action to be performed or a request relating to the second network node is associated with the energy metric. The method includes the second network node transmitting a second message towards the first network node, the second message comprising a response to the first message.

In another aspect there is provided a computer program comprising instructions which when executed by processing circuitry of a network node causes the network to perform the above described methods. In one embodiment, there is provided a carrier containing the computer program wherein the carrier is one of an electronic signal, an optical signal, a radio signal, and a computer readable storage medium. In another aspect there is provided a network node that is configured to perform the above described methods. The network node may include memory and processing circuitry coupled to the memory.

An advantage of the embodiments disclosed herein is the optimizing of network energy consumption (e.g. in case of mobility scenarios) using a distributed RAN-level solution, while maintaining an acceptable level of performance in terms, for instance, of coverage, capacity and quality of service. The embodiments disclosed herein introduce new signaling information between the RAN nodes that allows the said RAN nodes and their neighbors to gain a better understanding of the impact on the energy efficiency measured or predicted for one or more RAN nodes, due to planned/performed action/request where at least one the RAN nodes is involved. Improvement in the network energy efficiency may have a direct impact on the operational cost of the network.

### BRIEF DESCRIPTION OF THE DRAWINGS

The accompanying drawings, which are incorporated herein and form part of the specification, illustrate various embodiments.

FIG. 1 is an architecture diagram according to some embodiments.

FIG. 2 is a signaling diagram according to some embodiments.

FIG. 3 is a signaling diagram according to some embodiments.

FIGS. 4A-4C are signaling diagrams according to some embodiments.

FIG. 5 is a flowchart illustrating a process according to some embodiments.

FIG. 6 is a flowchart illustrating a process according to some embodiments.

FIG. 7 is a flowchart illustrating a process according to some embodiments.

FIG. 8 is a block diagram of an apparatus according to some embodiments.

FIG. 9 illustrates a message flow according to some embodiments.

FIG. 10 illustrates a node level architecture according to some embodiments.

FIG. 11 illustrates a node level architecture according to some embodiments.

FIG. 12 illustrates a node level architecture according to some embodiments.

FIG. 13 illustrates a node level architecture according to some embodiments.

FIG. 14A is a flowchart illustrating a process according to some embodiments.

FIG. 14B is a flowchart illustrating a process according to some embodiments.

FIG. 15 illustrates an E-UTRAN.

FIG. 16 illustrates a handover message flow.

FIG. 17 illustrates a high-level measurement model.

FIG. 18 illustrates a handover message flow.

FIG. 19A illustrates LTE reference signals.

FIG. 19B illustrates NR reference signals.

FIG. 20 illustrates an example of beam-level handover.

FIG. 21 illustrates a handover message flow.

### DETAILED DESCRIPTION

According to some embodiments, a network or RAN node may be any of (non-limiting list) gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB.

In the described embodiments, a first network node is a first or a source RAN node (e.g. a gNB or an eNB) and a second network node is a second or a target RAN node (e.g. another gNB or another eNB) and the communication between the first network node and the second network node can occur directly or indirectly (e.g. directly via XnAP, X2AP or indirectly via NGAP or S1AP) or via a third node (e.g. by means of a management entity such as OAM). In the embodiments disclosed herein, the first network node may be the source node of the mobility event, whilst the second network node may be the target node of a mobility event involving a UE.

According to some embodiments, a UE is any device (e.g., smartphone, tablet, computer, sensor, appliance, residential gateway, etc.) that is capable of wirelessly communicating with a RAN node. Power and energy consumption are important operational characteristics for UEs, affecting and in some cases mandating configurations when operating in certain network and traffic scenarios.

The term “transmit to” or “transmit towards” as used herein means “transmit directly or indirectly to.” Accordingly, transmitting a message to or towards a node encompasses transmitting the message directly to the node or transmitting the message indirectly to the node such that the message is relayed to the node via one or more intermediate nodes. Similarly, the term “receive from” as used herein means “receive directly or indirectly from.”

In one embodiment, a source RAN node initiating an action (e.g. related to mobility) towards a target RAN node, and optionally complemented by requests towards the target RAN node, indicates that the action and/or request is associated to energy saving. The indication can be included in the cause field of the message (e.g. as a cause value). Non-limiting examples of indications that the source RAN node may indicate to the target node include one or more of the following: handover desirable for Energy saving reasons, gNB Power Saving, action desirable for (or due to) Energy Saving Reasons, cell and/or an SSB beam and/or CSI-RS beam is/are (or will be) not Available for energy saving reasons, cell and/or an SSB beam and/or CSI-RS beam deactivation desirable (or planned) due to Energy Saving Reasons.

In an embodiment, an indication is used (e.g. a cause value), indicating that an action/request from a source RAN node to a target RAN node is initiated for energy saving reasons (e.g. to increase energy efficiency), and the said indication can be complemented by extra information pertaining to at least one intended/performed action associated to energy efficiency. Those actions may include an indication related to: reducing/transferring load from the source node, reducing capacity of the source node, by for example: (a) adjustments in the sleep mode state, i.e. the source node indicates activation of deeper sleep mode at the cost of longer activation time, (b) reducing the number of processing resources, (c) adjusting DTX cycle.

In an embodiment the indication (e.g. a cause value) indicating that an action from a source RAN node to a target RAN node is initiated for energy saving reasons, can be complemented by additional indications/requests to the target RAN node. Non-limiting examples of such indications/requests can relate to:

Indicating a measure of the amount/percentage of load being transferred from the source node to the target node/cell/SSB.

Requesting an update in the capacity of at least one of the cells/beams of the target node, by for example: adjustments in the sleep mode state, e.g. requesting the target node to reduce sleep mode to support offloading from source node; modifying the number of processing resources (e.g., increasing number of processing resources to support offloading from source node); and/or adjusting DTX cycle (e.g., reduce DTX cycle to support offloading from source node).

In another embodiment, extra information complementing the event due to energy saving may include one or more of the following:

An indication of amount or percentage of load that needs to be offloaded from the source cell/beam in order for the source cell/beam deactivation to take place.

An indication of the amount or percentage of load that needs to be offloaded from the source cell where energy efficiency needs to be improved or to reach a desired energy efficiency.

The amount/percentage of load (e.g. a configured target) at source RAN cell/beam for which the energy efficiency target is met.

The CGI of at least one cell of the source RAN node that is planned to be deactivated by the source RAN for energy efficiency reasons.

The CGI of at least one cell of the source RAN node for which energy efficiency is to be enhanced.

An indication of the implication of the action/request on the energy consumption status, e.g. actual/forecasted energy consumption/saving resulting from the amount of load to be offloaded. The energy consumption/saving information can be obtained according to the methods described in co-pending application titled Methods for inter-node reporting of energy consumption related information.

A time window, e.g. starting from a predefined point in time (e.g. the reception at target RAN node of the signaling containing information on load) within which the source RAN node is planning to transfer traffic to the target RAN node. This information would allow the target RAN node to take a decision on whether to admit the traffic that the source RAN needs to offload and to maintain the conditions needed to make such admission possible for the whole time duration signaled by the source.

The complementary information indicated by the source RAN node may allow the target RAN node to understand that, in order to achieve the energy efficiency objective desired by the source node, a certain amount of load needs to be absorbed and that after the target RAN has admitted such traffic, the source cell at the source RAN can perform the planned action and reach a desired energy efficiency. Optionally, this information can be used to set mobility policies for the target cell. For example, the amount of traffic that may be offloaded to the source cell in question is expected to be less due to its reduced capacity (such reduced capacity being caused by energy efficiency optimization) or even that the source cell/beam will be deactivated. Additionally, the target RAN may take proper mobility policies for its served UEs, taking into account that the source cell/beam, planned to be deactivated, will no longer be available for mobility, or is operating with reduced capacity. Such policies may for example request UEs to measure other frequency layers to prioritize or discover new potential HO target cells. The target RAN node may reply with new information (e.g. as part of the Xn: HO Request Acknowledge) specifying whether the load that needs to be offloaded by the source RAN node can be admitted by the target RAN node.

Among other procedures, indications (such as cause values) described above may be used for mobility scenarios such as: handover procedure and for Mobility Change Request procedure.

In one scenario, the source RAN node sends a HANDOVER REQUEST message to the target RAN node to request the preparation of resources for a handover, and the message includes a cause field which indicates that the HO request is due to Energy saving reasons, e.g. “handover desirable for Energy saving reasons”. Accordingly, the source node distinguishes a HO caused by energy saving decision from another HO request. Besides, such information exchange can be used by the (target) RAN node receiving incoming handover request(s) and comprising an indication of energy saving, e.g. to deduce the likelihood of potential deactivation of one or more cells (or beams) served by the (source) node, or to use such indication as input to decide upon the deactivation of one or more of its served cells (or beams) (e.g. a target RAN node receiving only incoming HO requests due to energy savings from a source RAN node, may consider such requests as not critical, and decide to not accept them, possibly, in turn, deactivating one or more of its cells (or beams).

In another scenario a MOBILITY CHANGE REQUEST (or any possible equivalent procedure designed for similar purposes) that is sent by a source RAN node to a target RAN node to initiate adaptation of mobility parameters and includes a cause field which supports the indication that the request is due to Energy saving reasons. Both procedures can be enhanced with the extra information listed in previous embodiments e.g. related to load reduction due to energy efficiency enhancements. As an example, the source RAN may trigger a Mobility Change Request towards the target RAN node and addressing one or more pairs of source and target cells, where the request indicates a contraction of the handover trigger point from source to target. Optionally the procedure may also propose a matching change in the handover trigger point for mobility from target to source. Such configuration may be associated to energy efficiency reasons. The Mobility Change Request may be complemented with any of the information described herein. As an example, the message from source to target may include an overall level of energy efficiency improvement achievable by the sending node if the mobility change request is successful. Accordingly, the target cell can accept/reject the request by taking into account the impact of this action on its own energy consumption, considering the balance between the cost of serving UEs in potentially sub-optimal radio conditions and the gain in terms of energy saving (as per the indication received in the cause and purpose of the mobility).

Such new energy saving causes may also be used for procedures different to the HO/mobility requests. For example, removal of PDU Sessions, radio bearers, transition to Idle of connected UEs, may all be due to energy efficiency purposes. The procedures used to enable such actions may carry the causes described herein, so to notify nodes involved with the procedures of the reason and purpose of such actions.

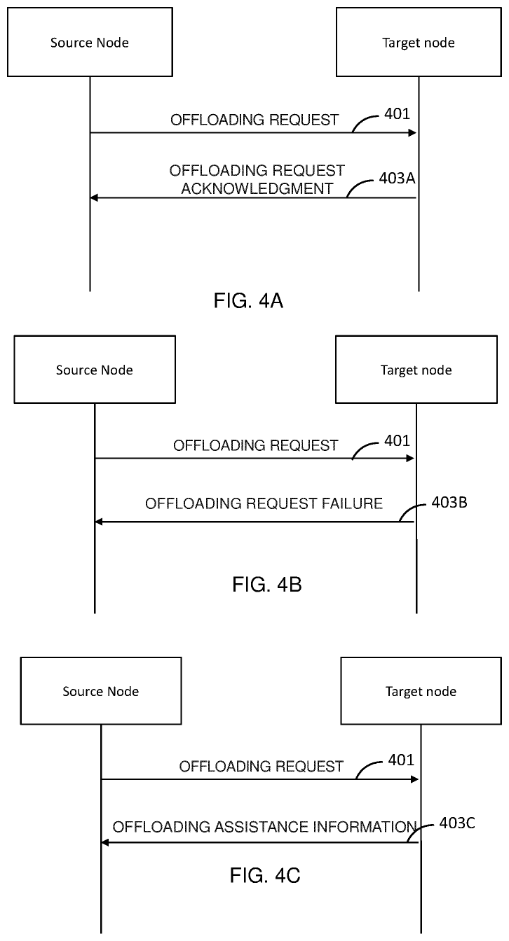

FIGS. 4A-4C illustrate signaling diagrams with respect to an offload request. If the source node decides to deactivate a cell/beam, it may go through the process of handing over UEs, without a guarantee that all the HO requests will be accepted. Alternatively, the source node can release the UEs and redirect them to a neighboring node, optionally after collecting measurements for a target node. It may be more efficient to introduce a procedure where a source RAN node checks if a neighboring node is willing to accept certain amount of traffic which can facilitate the deactivation decision. The neighboring node may accept the load as is (FIG. 4A), reject (FIG. 4B), or even propose the amount of traffic that it can accept (FIG. 4C). The source RAN node would also benefit from such a confirmation from the target RAN node in case of other planned actions by the source RAN node (e.g. reducing node/cell/beam capacity).

In one embodiment the information described above is exchanged by means of dedicated procedures aimed at determining if the target RAN node can admit the load the source RAN node needs to offload in order to for example deactivate the cell in question. Such procedures may occur before HO preparation procedures triggered for traffic offloading.

As part of this procedure, a source RAN node initiates the procedure by sending a request (401) to a target RAN node to acquire information about its willingness to accept taking over certain amount of load from the source node. The source node requests an indication if the reported requirements and amount of load can be served by the target node. The source RAN node before initiating a load transfer, sends a message to a target node indicating an amount of load that the source RAN node wishes to offload to the neighbor node due to energy saving reasons. As a non-limiting example, the report may include at least one of the following information: total Radio resource usage (GBR and non-GBR), data volume, total/average throughput, number of RRC connections, number of active UEs, radio conditions of the UEs to be offloaded and/or geographical location (which may include UE Radio measurements towards source and/or target node), served QoS flows, total amount of GBR and non GBR resources to be offloaded, load information such as those listed above, specified on a per network slice basis, e.g. on a per S-NSSA, information about the UE types to be offloaded (defined as, for example, UE categories, UE capabilities), a value that represent Energy savings/Consumption of source and/or target node (as a non-limiting example, estimated energy savings E_{source}/E_{target} if offloaded the requested traffic is signaled and/or the time window starting from a predefined point in time (e.g. the reception at target RAN of the signaling containing information on the offload) within which the source is planning to offload traffic to the target RAN. This information would allow the target RAN to take a decision on whether to admit the traffic source RAN needs to offload and to maintain the conditions needed to make such admission possible for the whole time duration signaled by the source. It should be noted that the information listed above may also be included in the embodiments described above concerning inclusion of information as part of the Handover Preparation procedure.

The target RAN node receives the request and performs one of the following actions: the target node sends a failure message (403B) with an appropriate cause value, if the requested action cannot be initiated (FIG. 4B), the target node sends a rejection message with an appropriate cause value if the requested load cannot be accepted, the target node sends an acknowledgment message (403A) to indicate that the proposed request can be accepted (FIG. 4A), or the target node may respond with a message with assistance information (403C) that includes alternative proposal if the request from the source node cannot be fulfilled (FIG. 4C). Such alternative proposal may consist of an acceptable amount of traffic that can be offloaded towards the target RAN node, such as a maximum or a minimum amount of traffic, described in accordance to the load information description herein.

The target node can be configured with rejection criteria. For example, the target node can reject the request: if the estimated energy increase in target with the offloaded traffic is larger than E_{source}; if the estimated energy increase in target is above a certain threshold; if the estimated energy increase in target does not match the estimated one E_{target} by the source node; if there are not enough radio resources to accommodate for the offloaded load.

In one case of failure/reject, the target node may have received requests related to offload from the source RAN node while also receiving requests to offload traffic from a third RAN node, and at least one of the two requests cannot be fulfilled.

In another situation resulting in failure/reject, the target RAN node, receiving incoming offload request from the source RAN node, may be in the process to request to a third RAN node an offload of traffic, and the incoming request from the first RAN node cannot be fulfilled. As an example, this can be due an ongoing soft lock of at least one of the cells served by the target RAN node and/or a (more or less sudden) change in the load at the target RAN node which will make not possible for the target RAN node to serve the potential load transferred from the source RAN node (at all, or at least to for a certain time interval) with the desired level of QoS or QoE.

The response from the target RAN node described above may also be included in the embodiments described above concerning inclusion of information as part of the Handover Preparation procedure.

Based on the response from the target node, the source RAN node can proceed or cancel with the offloading procedure based on the obtained information from the target RAN node.

In another embodiment, neighboring nodes may have conflicting policies/rules/configurations when it comes to energy consumption targets. If each node attempts to optimize the network energy consumption (or several RAN nodes energy consumption) from its own point of view and in a distributed manner without knowledge about other nodes' policies, it will be difficult to converge to one optimal solution. Therefore, it may beneficial to exchange between the nodes the preferred energy efficiency policy to follow. Those policies, may be configured by a management entity, e.g. OAM. Such policies can be forwarded from a source RAN node to a target RAN node or vice versa. For instance:

One of the source node or target node can explicitly indicates if it is operating in energy/power saving mode (low power consumption mode) or in normal mode (were energy saving is not a priority). This information can facilitate energy saving related decisions taken at another node when attempting to reduce its power consumption. For example, if a target node indicates Power saving mode, other neighboring nodes should not consider (or down prioritize) the target node as a candidate node for load transfer, or reduce the amount of load transferred towards the said node. If a target node indicates that is operating in normal mode (or it does not indicate that it operates in energy saving mode), a source RAN node can deduce that the target node is willing to accept incoming mobility requests to transfer some load from the source node to the target node.

The node indicates a preferred energy consumption state for operation. Given this information, the neighboring nodes should avoid any energy savings actions that will violate or exceed the indicated preference.

The node indicates a preferred load state for operation. Given this information, the neighboring nodes should avoid any Energy savings actions that will violate or exceed the indicated preference.

The node indicates deactivation of energy saving functionalities.

The node indicates the margin for acceptable energy level increase. Given this information, the neighboring nodes should avoid any Energy savings actions that will violate or exceed the indicated preference.

In case the source and target nodes are different gNB-DUs connected to the same gNB-CU-CP, the gNB-CU-CP can act as coordination entity between the two (or more) gNB-DUs, and exchange/update of energy efficiency policies between the gNB-DUs can be done via the gNB-CU-CP. This information can be exchanged reusing existing procedures (e.g. on resource status information) or new signaling. As an example, if two gNB-DUs are connected to the same gNB-CU-CP and the gNB-DUs realize cells that can be used in Carrier Aggregation, energy saving can be obtained by regulating Carrier Aggregation options or MIMO options for the cells served by the RAN node. The same is also valid for the case of multiple cells realized by one gNB-DU. In case the coverage areas of some or all of the cells realized by the gNB-DU(s) are totally or partially overlapping, one goal of exchanging/updating energy efficiency policies can be to advise the gNB-Dus to avoid using certain cells in order to allow those cells to be switched off or to exploit the low load situation by entering deeper sleep modes. Energy Efficiency (EE) policy exchange/update can be sent from a gNB-CU-CP to a gNB-DU via an existing procedure over F1AP (e.g. Access and Mobility Indication) or using a new dedicated procedure.

In another embodiment, the source node may indicate to the target node validity criteria concerning the load transfer or offload due to energy saving reasons. Such criteria can be used by the source node to enable/disable the load transfer due to energy saving reasons. The same criteria can be forwarded to the target node, to support the target node in assessing the expected load that can be received from the source node due to energy efficiency reasons. This can be used for better coordination of similar actions between neighbor nodes.

The source node may be configured, e.g. from OAM, with validity criteria to be used to enable/disable load transfer due to energy saving reasons. Such criteria can be forwarded from the source node to the target node.

Non-limiting examples of validity criteria may include any one of, or a combination of the following:

Operator constraints indicating a time period during which load transfer due to energy efficiency is not desirable (e.g. during special events).

Operator constraints, e.g. connected to specific performance indicators (e.g. accessibility of a given service should not be less than X1%, drop rate of a given service should not be higher than X2%, packet loss not higher than X3, packet delay for a service not higher than X4, etc).

Operator constraints, e.g. connected to specific services, S-NSSAIs

Constraints, on a cell or SSB level, indicating that at node level, or within the cells or the SSBs areas served by the source node, at least one cell or at least on SSB shall/should/cannot be considered for Energy saving related decisions.

Activation or deactivation of energy saving function in combination with aspects concerning the air interface transmission/reception that can impact energy consumption of more than one cell or more than one transmission point at same time, e.g. Coordinated Multi-point, Multiple-Transmission Points.

Possibility of coexistence of energy saving opportunities with functionalities concerning duplication of packet transmission/reception to ensure high reliability.

Activation or deactivation of energy saving function based on QoE related indication.

Activation or deactivation of energy saving function based on temperature indication.

Similarly, the target node may indicate to the source node, validity criteria concerning potential load transfer or offload from the source node due to energy saving reasons.

There may be several methods to use machine learning (ML) models to build knowledge on how moving a UE between a source and a target cell will affect the UE KPI. The use of energy saving action in a target node will affect the UE KPI in said cell if moved from the source cell. Hence, the energy saving configuration signaling from a target to a source cell can be included in the ML-model for improved KPI prediction. The network can then learn using ML how to set better actions also when a node has energy saving actions, leading to improved network performance.

For the inter-frequency handover, an ML-model can be used in order to detect a node on another frequency using target carrier prediction as described in WO2017162262 entitled Target Carrier Radio Predictions Using Source Carrier Measurements, which is fully incorporated herein by reference. Target carrier prediction requires the UE to measure only on its source carrier. Using target carrier prediction with source carrier measurements, the UE does not need to perform inter-frequency measurements, leading to energy savings at the UE. In case the coverage due to energy savings is different on another carrier (e.g., sleeping cell or antenna sleep, reduced bandwidth), it will lead to an inaccurate model. One can include the energy saving action related to the secondary carrier in order for the model to take this into account.

In one embodiment, the ML model can be trained and inferred in a source or target node. In another embodiment, the source or target node may receive the trained model from a second node (e.g. OAM or another RAN node). Non-limiting examples of machine learning models may include differently configured supervised learning algorithms, reinforcement learning algorithms, contextual multi-armed bandit algorithm, autoregression algorithms, etc.

In another embodiment the offload request and response are transferred over Xn. In the following an example is provided with one of the possible messages that can be exchanged over Xn. All or a subset of the information described in the Offload Request in Table 3 below can be included in the message, additional information is not excluded. This message is sent by the source NG-RAN node to the target NG-RAN node to acquire confirmation about possibility to offload certain amount of load from the source node.

TABLE 3
Offload Request

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| Source NG- | M | | NG-RAN node | Allocated at | YES | reject |
| RAN node | | | UE XnAP ID | the source | | |
| UE XnAP ID | | | 9.2.3.16 | NG-RAN | | |
| reference | | | | node | | |
| Cause | M | | 9.2.3.2 | | YES | reject |
| Target Cell | M | | 9.2.3.25 | Includes | YES | reject |
| Global ID | | | | either an E- | | |
| | | | | UTRA CGI | | |
| | | | | or an NR | | |
| | | | | CGI | | |
| GUAMI | M | | 9.2.3.24 | | YES | reject |
| Load | | 1 | | | YES | Reject |
| Information | | | | | | |
| >Number of | O | | 9.2.2.62 | | | |
| active UEs | | | | | | |
| >Number of | O | | 9.2.2.57 | | | |
| RRC | | | | | | |
| connections | | | | | | |
| > Total Radio | O | | 9.2.2.xx | | | |
| resource | | | | | | |
| usage | | | | | | |
| >QOS Flows | O | 1 | | | — | |
| To Be | | | | | | |
| Offloaded | | | | | | |
| List | | | | | | |
| >>QOS | | 1 . . . | | | — | |
| Flows To Be | | <maxnoofQoSFlows> | | | | |
| offloaded | | | | | | |
| Item | | | | | | |
| >>>QOS | M | | 9.2.3.10 | | — | |
| Flow | | | | | | |
| Identifier | | | | | | |
| >>>QoS | M | | 9.2.3.5 | | — | |
| Flow Level | | | | | | |
| QoS | | | | | | |
| Parameters | | | | | | |
| >UE To Be | | | | | | |
| offloaded List | | | | | | |
| >> UE to Be | | | | | | |
| offloaded | | | | | | |
| Item | | | | | | |
| >>> UE | | | 9.2.3.17 | | | |
| Aggregate | | | | | | |
| Maximum Bit | | | | | | |
| Rate | | | | | | |
| >>>UE Radio | O | | 9.2.3.138 | | YES | Reject |
| Capability ID | | | | | | |
| >Energy | O | | 9.2.2.x | | | |
| consumption | | | | | | |
| IE | | | | | | |

The Radio Resource Usage IE indicates the usage of the PRBs per cell and per SSB area similar to Radio Resource Status IE however the report is limited to the traffic to be offloaded in Downlink and Uplink and the usage of PDCCH CCEs for Downlink and Uplink scheduling.

The Energy consumption IE indicates the energy consumption or savings at the source node.

Table 4 below shows the information that may be included in an offload request acknowledge message sent by NG-RAN node₂ to indicate to NG-RAN node₁ that OFFLAD REQUEST proposed by NG-RAN node₁ can be accepted.

TABLE 4

| | | | | Semantics | | Assigned |
|---|---|---|---|---|---|---|
| IE/Group Name | Presence | Range | IE type and reference | description | Criticality | Criticality |
| Message Type | M | | 9.2.3.1 | | YES | reject |
| NG-RAN node1 Cell ID | M | | Global NG-RAN Cell | | YES | reject |
| | | | Identity | | | |
| | | | 9.2.2.27 | | | |
| NG-RAN node2 Cell ID | M | | Global NG-RAN Cell | | YES | reject |
| | | | Identity | | | |
| | | | 9.2.2.27 | | | |
| Criticality Diagnostics | O | | 9.2.3.2 | | YES | ignore |

Table 5 below shows the information that may be included in an offload request failure message that may be sent by the NG-RAN node₂ to indicate to NG-RAN node₁ that Proposed load to be offloaded by NG-RAN node₁ is refused.

TABLE 5

| | | IE type and | Criti- | Assigned |
|---|---|---|---|---|
| IE/Group Name | Presence | reference | cality | Criticality |
| Message Type | M | 9.2.3.1 | YES | reject |
| NG-RAN node1 | M | Global NG-RAN | YES | ignore |
| Cell ID | | Cell Identity | | |
| | | 9.2.2.27 | | |
| NG-RAN node2 | M | Global NG-RAN | YES | ignore |
| Cell ID | | Cell Identity | | |
| | | 9.2.2.27 | | |
| Cause | M | 9.2.3.2 | YES | ignore |
| Load Capacity Range | O | 9.2.2.x | YES | ignore |
| Criticality Diagnostics | O | 9.2.3.2 | YES | ignore |

Table 6 below shows a Load capacity Range IE, which indicates the maximum load that can be accepted from the source node.

TABLE 6

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | | 9.2.3.1 | YES | reject |
| Type | | | | | |
| NG-RAN | M | | Global NG- | YES | ignore |
| node1 Cell | | | RAN Cell | | |
| ID | | | Identity | | |
| | | | 9.2.2.27 | | |
| NG-RAN | M | | Global NG- | YES | ignore |
| node2 Cell | | | RAN Cell | | |
| ID | | | Identity | | |
| | | | 9.2.2.27 | | |
| Cause | M | | 9.2.3.2 | YES | Ignore |
| Load | | 1 | | YES | Reject |
| Information | | | | | |
| >Number of | O | | 9.2.2.62 | | |
| active UEs | | | | | |
| >Number of | O | | 9.2.2.57 | | |
| RRC | | | | | |
| connections | | | | | |
| > Total Radio | O | | 9.2.2.xx | | |
| resource | | | | | |
| offered | | | | | |
| >QoS Flows | O | 1 | | — | |
| can Be | | | | | |
| Offloaded | | | | | |
| List | | | | | |
| >>QoS | | 1 . . . | | — | |
| Flows can | | <maxnoofQoSFlows> | | | |
| Be offloaded | | | | | |
| Item | | | | | |
| >>>QoS | M | | 9.2.3.10 | — | |
| Flow | | | | | |
| Identifier | | | | | |
| >>>QoS | M | | 9.2.3.5 | — | |
| Flow Level | | | | | |
| QoS | | | | | |
| Parameters | | | | | |

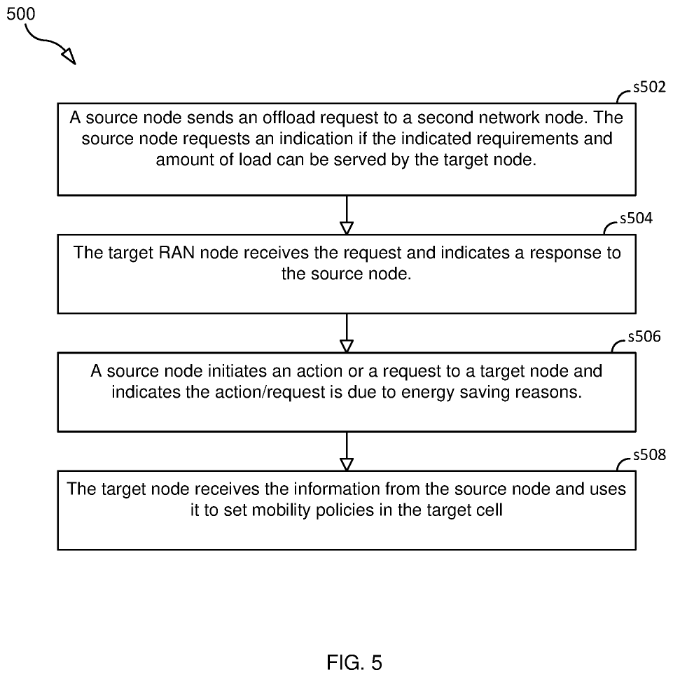

FIG. 5 is a flowchart illustrating a process 500 according to some embodiments. The source node of the mobility event may be a first node, and the target node of the mobility even may be a second network node. At step 502, a source node sends an offload request to a target node. The source node requests an indication if the indicated requirements and amount of load can be served by the target node. At step 504, the target node receives the request and indicates a response to the source node. The target node may indicate accepts, rejection, or modified request to the source node. At step 506, a source node initiates an action or a request to a target node and indicates the action/request is due to energy saving reasons. The signaled message optionally includes the intended/performed energy efficiency action/request and/or information complementing the new energy saving cause values. At step 508, the target node receives the information from the source node and uses it to set mobility policies in the target cell.

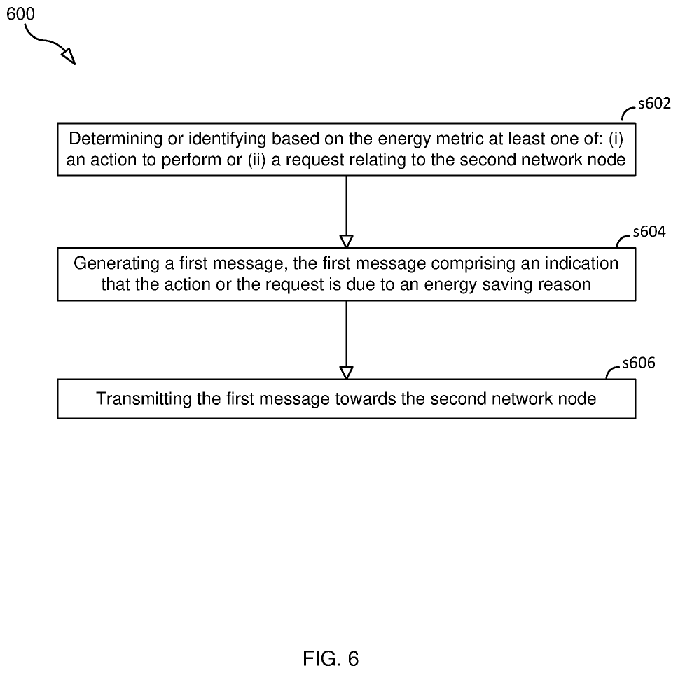

FIG. 6 is a flow chart illustrating a process 600, according to some embodiments. Process 600 may be performed by a first network node for coordinating with a second network node with respect to an energy metric. In one example, the first network node may be a source node of the mobility event, whilst the second network node may be a target node of a mobility event involving a UE. At step 602, the process includes determining or identifying based on the energy metric at least one of: (i) an action to perform or (ii) a request relating to the second network node. At step 604, the process includes generating a first message, the first message comprising an indication that the action or the request is due to an energy saving reason. At step 606, the process includes the first network node transmitting the first message towards the second network node.

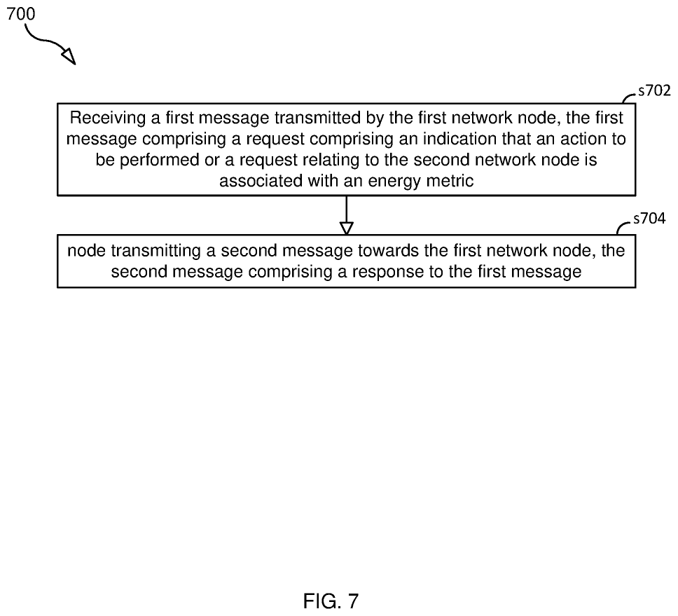

FIG. 7 is a flow chart illustrating a process 700 according to some embodiments. Process 700 may be performed by a second network node for coordinating with a first network node with respect to an energy metric. In one example, the first network node may be the source node of the mobility event, whilst the second network node may be the target node of a mobility event involving a UE. At step 702, a first message transmitted by the first network node is received, the first message comprising a request comprising an indication that an action to be performed or a request relating to the second network node is associated with the energy metric. At step 704, a second message is transmitted towards the first network node, the second message comprising a response to the first message.

### Additional Disclosure

### 1. Third Generation Partnership Project (3GPP) LTE System Architecture (SA)

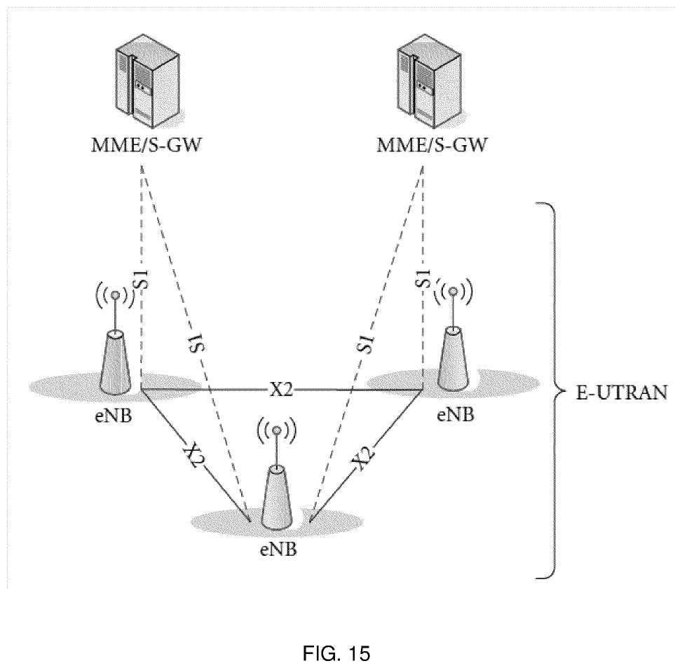

3GPP has specified the Long Term Evolution (LTE) Evolved Universal Terrestrial Radio Access Network (E-UTRAN) architecture. As illustrated in FIG. 15, LTE E-UTRAN comprises base stations, which are referred to as “evolvedNodeBs (eNBs),” Mobility Management Entities (MMEs), and System Architecture Evolution Gateways (S-GWs). As further shown in FIG. 15, an S1 interface connects the eNBs to the MME/S-GW, and connectivity between eNBs is supported by an X2 interface.

### 2. 3GPP Next Generation (NG) Radio Access Network (NG-RAN) SA

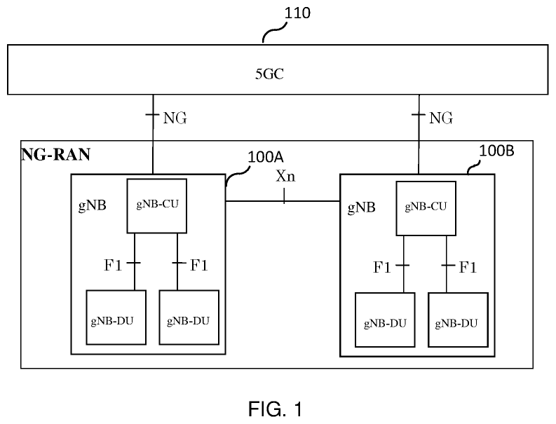

The current fifth generation (5G) RAN (NG-RAN) (which is also referred to as New Radio (NR)) architecture is illustrated in FIG. 1 and described in 3GPP Technical Specification (TS) 38.401 v15.4.0. The NG-RAN architecture can be further described as follows. The NG-RAN includes of a set of base stations that are called “gNBs,” and the gNBs are connected to the 5G Core Network (5GC) through the NG interface. A gNB can be connected to another gNB through the Xn interface. A gNB may consist of a gNB central unit (gnB-CU) and one or more gNB distributed units (gnB-DUs_. A gNB-CU and a gNB-DU are connected via the F1 logical interface. For resiliency, a gNB-DU may be connected to multiple gNB-CU by appropriate implementation. The NG interface, the Xn interface, and the F1 interface are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signalling transport.

A gNB may also be connected to an eNB via the X2 interface. Another architectural option is that where an eNB connected to an Evolved Packet Core (EPC) network is connected over the X2 interface with a so called nr-gNB. The latter is a gNB not connected directly to a core network (CN) and connected via X2 to an eNB for the sole purpose of performing dual connectivity.

The architecture in FIG. 1 can be expanded by spitting the gNB-CU into two entities. One gNB-CU-UP, which serves the user plane (UP) and hosts the Packet Data Convergence Protocol (PDCP) protocol and one gNB-CU-CP, which serves the control plane (CP) and hosts the PDCP and Radio Resource Control (RRC) protocol. A gNB-DU also hosts lower layer protocols.

### 3. Energy Savings in LTE and NR Systems

### 3.1 RAN Energy Saving

It is advantageous to reduce the operational cost of the RAN through energy savings. This can be achieved by, among other things, turning on/off capacity cells to lower the energy consumption. The decision is typically based on cell load information. The decision can be taken by a RAN node (e.g., base station) or also by an Operation and Maintenance (O&M) function.

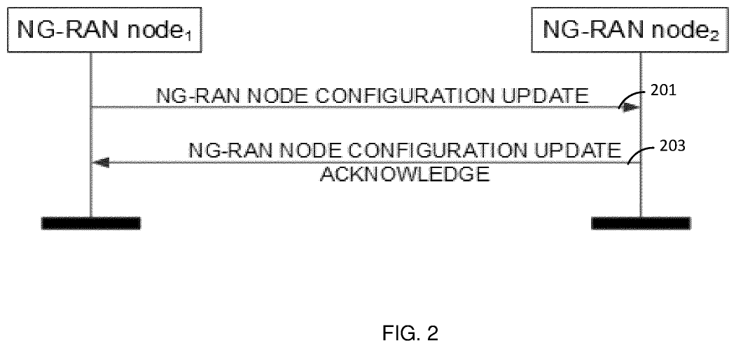

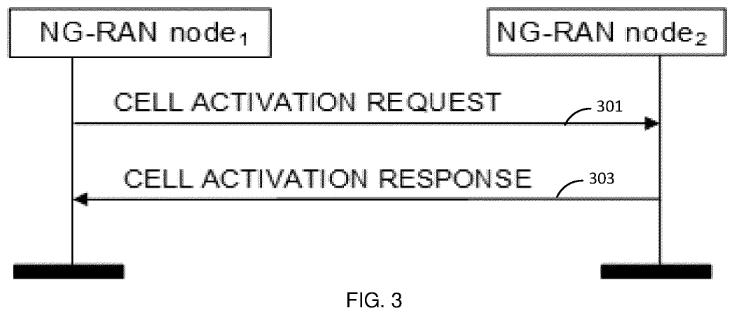

A gNB serving a cell that the gNB has deactivated in order to reduce energy consumption can inform a neighboring node of the deactivation by means of an NG-RAN node Configuration Update procedure over the Xn interface, as illustrated in FIG. 2 and described in 3GPP TS 38.423 v16.5.0. Additionally, a gNB node can request another gNB to switch on/off a cell by means of Cell Activation procedure over Xn interface.

Additionally, a RAN node may take an energy saving action (e.g., an action to increase energy efficiency or reduce energy consumption) by reducing load in its served cells. Such reduction in load may translate into reducing the number of served user equipments (UEs) or the number of bearers, and, therefore it may enable the activation of idle periods in the usage of certain functions, such reduction in use consequently generating a saving in energy consumption.

### 3.2 UE Energy Savings

A UE is any device (e.g., smartphone, tablet, computer, sensor, appliance, residential gateway, etc.) that is capable of wirelessly communicating with a RAN node. Power and energy consumption are important operational characteristics for UEs, affecting and in some cases mandating configurations when operating in certain network and traffic scenarios. The network (NW) is expected to allow configurations where these are minimized to avoid overheating and to extend UE battery life, respectively.

There are several ways in which a UE can reduce energy consumption. These include: (1) increasing the fraction of time that the UE spends in a sleep state, especially a deep sleep where radio frequency (RF) circuitry and/or other circuitry is turned off, and (2) when monitoring signals, operating at minimum necessary receiver configurations, e.g., few antennas, narrow bandwidth (BW), minimum necessary RF quality, etc. The NW can enable and assist this by configuring and signaling to the UE numerous mechanisms. With reference to NR, a gNB can:
Configure signal monitoring (DRX) timelines that allow short monitoring intervals and long sleep intervals between them:
   Connected DRX for data scheduling in connected mode (e.g., period, onDuration length)
   DRX for paging monitoring in idle/inactive modes (e.g., period, PO length, number of POs)
Minimize inactivity timers
   cDRX inactivity timer from last data scheduling to returning to cDRX,
   Data inactivity time from last data scheduling to returning to idle mode
Enable mechanisms that pre-signal whether monitoring is necessary in upcoming intervals
   WUS in connected mode to indicate status of next onDuration
   PEI in idle mode to indicate status of next PO
Guarantee sufficient time for receiver reconfiguration from a minimal to a performance-optimized mode
   Cross-slot scheduling specifying a minimum PDCCH/PDSCH distance
   Indicate a PDCCH skipping duration
   Search space (periodicity) adaptation
Provide guarantees about maximum required receiver performance to handle scheduled data formats
   Indication of maximum MIMO layers that will be scheduled
Avoid unnecessary measurements that diminish UE sleep opportunities
   UE measurement reduction in connected mode for stationary UEs in good conditions
Activate UAI functionality for the UE to indicate specific configuration preferences, etc.
Measurement relaxation, e.g., RRM, RLM, BFD in connected or idle (RRC_idle/inactive) mode.
Reduction of power consumption over Scells, e.g., by dynamic Scell release or activation/deactivation, Scell dormancy, etc.

### 4. Mobility and Handover in Radio Networks

4.1 Mobility in the LTE system

When the NW determines that a signal degradation for the serving cell of a UE and that a neighboring cell (a.k.a., a target cell) could serve the UE with a better signal quality, a handover procedure between the serving cell and the target cell can be initiated (e.g., a handover procedure between the eNB providing the serving cell and the eNB providing the target cell). A handover procedure may additionally be initiated to balance the load between cells, and therefore optimize the usage of the system resources and increase the system throughput.

The eNBs providing the serving cell and the target cell may directly exchange load information by using the X2 interface prior to initiating a handover preparation procedure so as to avoid moving a UE to a loaded cell which, despite having a stronger radio signal towards the UE, may not be able to serve the UE with sufficient radio resources. In this case, initiating the handover would degrade the performance of the UE moved to the target cell as well as of the UEs already connected to the target cell (since the available radio resources would be shared among more UEs).

To determine whether a handover decision should be made, the UE can be configured to periodically, or upon the occurrence of an event, send to the serving eNB a measurement report (e.g., through uplink by using radio resource control (RRC) signaling).

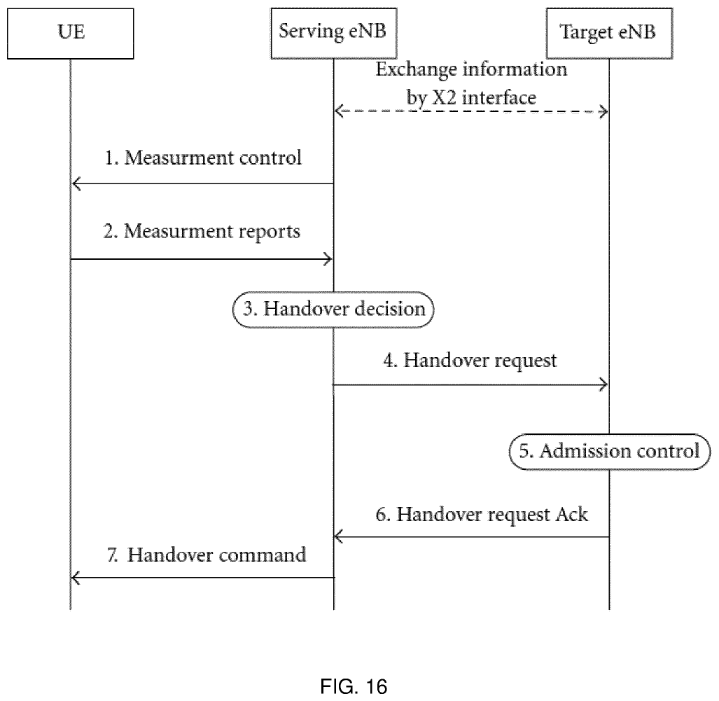

The handover procedure in a 3GPP LTE system has three phases: handover preparation, handover execution, and handover completion. When the conditions to start a handover preparation are met, the handover preparation procedure is mainly made up for a handover decision stage in serving eNB and for an admission control stage in target eNB as shown in FIG. 16, which illustrates an example handover message flow.

In an LTE system, the handover decision in the handover preparation procedure is made by the radio resource management (RRM) function based on the measurement report from the UE. To avoid ping-pong effects between source and target eNBs, the handover decision made by the serving eNB shall meet a robust handover criterion comprising threshold parameters for signal strength, hysteresis, and time to trigger.

The initial handover condition to be met for a positive handover decision is that the received signal strength (RSS) of the serving eNB is less than a given threshold value. In order to make the handover decision more robust, a signal strength threshold and a hysteresis operation can be enforced for the signal measured from the target eNB. In essence, if the candidate target eNB provides a higher RSS than that of the serving eNB during a period of time, a hysteresis operation is considered by the serving eNB for the target eNB. Once the conditions to trigger a handover procedure are met, a handover request is transmitted from the serving eNB to the target eNB. If the UE can be admitted by the target eNB, a handover request acknowledgment (Ack) message is transmitted back from the target eNB to the serving eNB. At this point, the serving eNB can issue a handover command to the UE to begin the handover, as shown in FIG. 16.

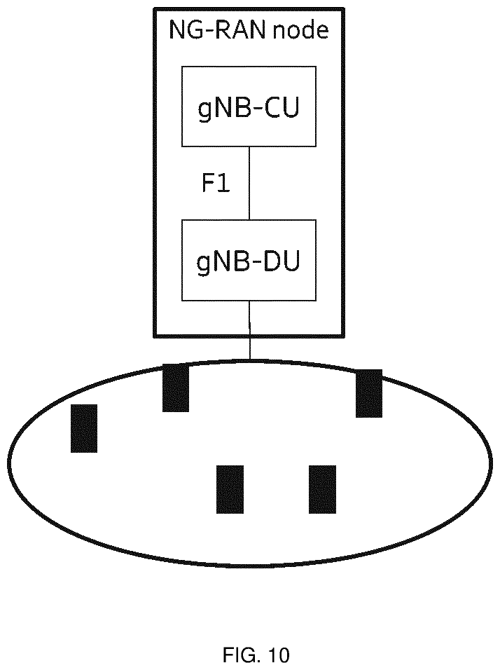

FIG. 10.1.2.1.1-1 of 3GPP TS 36.300 v16.5.0 shows an illustration of the of Intra-MME/Serving Gateway handover for the 3GPP LTE-A system. Steps 7 to 16 provide means to avoid data loss during HO and are discussed in detail in Sections 10.1.2.1.2 and 10.1.2.3 of 3GPP TS 36.300. In step 7, the target eNB generates the RRC message to perform the handover, i.e. RRCConnectionReconfiguration message including the mobilityControlInformation, to be sent by the source eNB towards the UE. The source eNB performs the necessary integrity protection and ciphering of the message.

The UE receives the RRCConnectionReconfiguration message with necessary parameters (i.e. new C-RNTI, target eNB security algorithm identifiers, and optionally dedicated RACH preamble, target eNB SIBs, etc.) and is commanded by the source eNB to perform the HO. If RACH-less HO is configured, the RRCConnectionReconfiguration includes timing adjustment indication and optionally preallocated uplink grant for accessing the target eNB. If preallocated uplink grant is not included, the UE should monitor PDCCH of the target eNB to receive an uplink grant. The UE does not need to delay the handover execution for delivering the HARQ/ARQ responses to source eNB.

If Make-Before-Break HO is configured, the connection to the source cell is maintained after the reception of RRCConnectionReconfiguration message with mobilityControlinformation before the UE executes initial uplink transmission to the target cell. In this case, the source eNB can deliver/receive additional user plane data to/from the UE. If Make-Before-Break HO is configured, the source eNB decides when to stop transmitting to the UE

### 4.2 Mobility in the NR System

The basic mobility solution in NR shares some similarities to LTE. The UE may be configured by the network to perform cell measurements and report them, to assist the network to take mobility decisions. However, a difference is that the UE may be configured to perform L3 beam measurements based on different reference signals (SSBs and CSI-RSs) and report them, for each serving and triggered cells, i.e. for each cell fulfilling triggering conditions for measurement report (e.g. A3 event).

### 4.3 Measurements to Support Mobility in NR

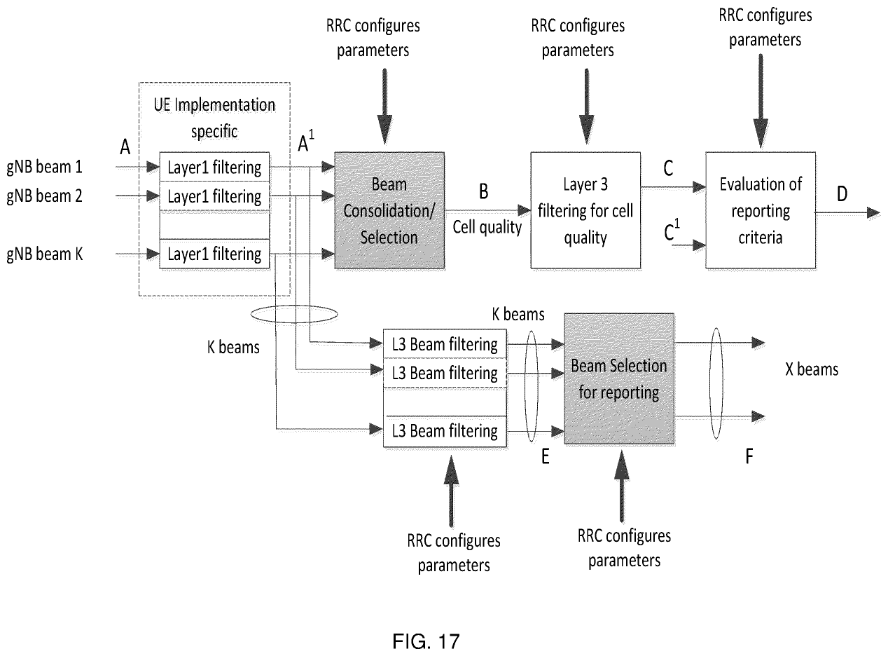

The measurement model in NR, as described in TS 38.300 v16.5.0 states that in RRC_CONNECTED, the UE measures multiple beams (at least one) of a cell and the measurements results (power values) are averaged to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the X best beams if the UE is configured to do so by the gNB. The corresponding high-level measurement model is illustrated in FIG. 17. Referring now to FIG. 17:

K beams correspond to the measurements on Synchronization Signal Block (SSB) or Channel State Information (CSI) Reference signal (RS) (CSI-RS) resources configured for L3 mobility by gNB and detected by UE at L1. A: measurements (beam specific samples) internal to the physical layer. Layer 1 filtering: internal layer 1 filtering of the inputs measured at point A. Exact filtering is implementation dependent. How the measurements are actually executed in the physical layer by an implementation (inputs A and Layer 1 filtering) in not constrained by the standard. A¹: measurements (i.e. beam specific measurements) reported by layer 1 to layer 3 after layer 1 filtering. Beam Consolidation/Selection: beam specific measurements are consolidated to derive cell quality. The behaviour of the Beam consolidation/selection is standardised and the configuration of this module is provided by RRC signalling. Reporting period at B equals one measurement period at A¹. B: a measurement (i.e. cell quality) derived from beam-specific measurements reported to layer 3 after beam consolidation/selection. Layer 3 filtering for cell quality: filtering performed on the measurements provided at point B. The behaviour of the Layer 3 filters is standardised and the configuration of the layer 3 filters is provided by RRC signalling. Filtering reporting period at C equals one measurement period at B. C: a measurement after processing in the layer 3 filter. The reporting rate is identical to the reporting rate at point B. This measurement is used as input for one or more evaluation of reporting criteria. Evaluation of reporting criteria: checks whether actual measurement reporting is necessary at point D. The evaluation can be based on more than one flow of measurements at reference point C e.g. to compare between different measurements. This is illustrated by input C and C¹. The UE shall evaluate the reporting criteria at least every time a new measurement result is reported at point C, C¹. The reporting criteria are standardised and the configuration is provided by RRC signalling (UE measurements). D: measurement report information (message) sent on the radio interface. L3 Beam filtering: filtering performed on the measurements (i.e. beam specific measurements) provided at point A¹. The behaviour of the beam filters is standardised and the configuration of the beam filters is provided by RRC signalling. Filtering reporting period at E equals one measurement period at A¹. E: a measurement (i.e. beam-specific measurement) after processing in the beam filter. The reporting rate is identical to the reporting rate at point A¹. This measurement is used as input for selecting the X measurements to be reported. Beam Selection for beam reporting: selects the X measurements from the measurements provided at point E. The behaviour of the beam selection is standardised and the configuration of this module is provided by RRC signalling. F: beam measurement information included in measurement report (sent) on the radio interface.

Measurement reports are characterized by the following:

Measurement reports include the measurement identity of the associated measurement configuration that triggered the reporting; Cell and beam measurement quantities to be included in measurement reports are configured by the network; The number of non-serving cells to be reported can be limited through configuration by the network; Cells belonging to a blacklist configured by the network are not used in event evaluation and reporting, and conversely when a whitelist is configured by the network, only the cells belonging to the whitelist are used in event evaluation and reporting; and Beam measurements to be included in measurement reports are configured by the network (beam identifier only, measurement result and beam identifier, or no beam reporting).

Intra-frequency neighbour (cell) measurements and inter-frequency neighbour (cell) measurements are defined as follows:
SSB based intra-frequency measurement: a measurement is defined as an SSB based intra-frequency measurement provided the centre frequency of the SSB of the serving cell and the centre frequency of the SSB of the neighbour cell are the same, and the subcarrier spacing of the two SSBs is also the same;
SSB based inter-frequency measurement: a measurement is defined as an SSB based inter-frequency measurement provided the centre frequency of the SSB of the serving cell and the centre frequency of the SSB of the neighbour cell are different, or the subcarrier spacing of the two SSBs is different (for SSB based measurements, one measurement object corresponds to one SSB and the UE considers different SSBs as different cells);
CSI-RS based intra-frequency measurement: a measurement is defined as a CSI-RS based intra-frequency measurement provided the bandwidth of the CSI-RS resource on the neighbour cell configured for measurement is within the bandwidth of the CSI-RS resource on the serving cell configured for measurement, and the subcarrier spacing of the two CSI-RS resources is the same; and
CSI-RS based inter-frequency measurement: a measurement is defined as a CSI-RS based inter-frequency measurement provided the bandwidth of the CSI-RS resource on the neighbour cell configured for measurement is not within the bandwidth of the CSI-RS resource on the serving cell configured for measurement, or the subcarrier spacing of the two CSI-RS resources is different.

### 4.3 Cell-Level Mobility in NG-RAN

Section 9.2.3 of the 3GPP TS 38.300 specify the cell-level mobility for the NG-RAN system. Network controlled mobility applies to UEs in RRC_CONNECTED and is categorized into two types of mobility: cell level mobility and beam level mobility.

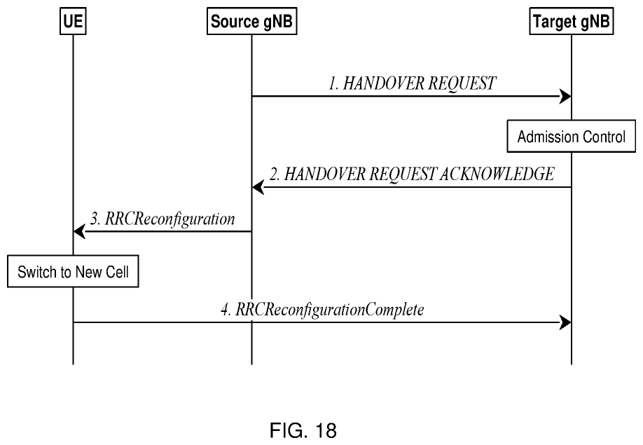

Cell Level Mobility requires explicit RRC signalling to be triggered, i.e. handover. For inter-gNB handover, the signalling procedures consist of at least the following elemental components illustrated in FIG. 18 and described in 3GPP TS 38.300. The procedure consists if the following steps:
1. The source gNB initiates handover and issues a HANDOVER REQUEST over the Xn interface.
2. The target gNB performs admission control and provides the new RRC configuration as part of the HANDOVER REQUEST ACKNOWLEDGE.
3. The source gNB provides the RRC configuration to the UE by forwarding the RRCReconfiguration message received in the HANDOVER REQUEST ACKNOWLEDGE. The RRCReconfiguration message includes at least cell ID and all information required to access the target cell so that the UE can access the target cell without reading system information. For some cases, the information required for contention-based and contention-free random access can be included in the RRCReconfiguration message. The access information to the target cell may include beam specific information, if any.
4. The UE moves the RRC connection to the target gNB and replies with the RRCReconfigurationComplete. User Data can also be sent in step 4 if the grant allows.

The handover mechanism triggered by RRC requires the UE at least to reset the MAC entity and re-establish radio link control (RLC). RRC managed handovers with and without PDCP entity re-establishment are both supported. For data radio bearers (DRBs) using RLC acknowledge mode (AM), PDCP can either be re-established together with a security key change or initiate a data recovery procedure without a key change. For DRBs using RLC un-acknowledge mode (UM) and for signaling radio bearers (SRBs), PDCP can either be re-established together with a security key change or remain as it is without a key change.

Data forwarding, in-sequence delivery, and duplication avoidance at handover can be guaranteed when the target gNB uses the same DRB configuration as the source gNB. Timer based handover failure procedure is supported in NR. RRC connection re-establishment procedure is used for recovering from handover failure.

### 4.5 Beam-Level Mobility in NG-RAN

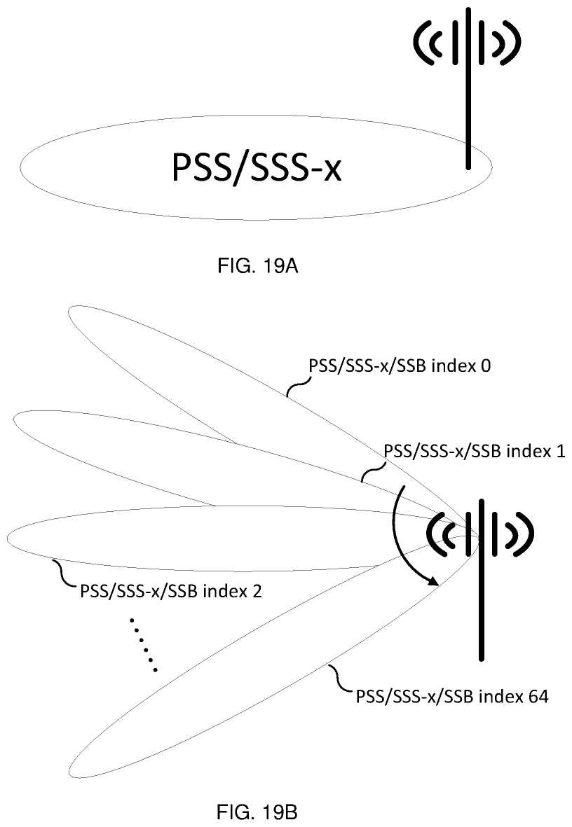

In LTE and NR, handovers decisions or Primary Secondary Cell (PSCell) change decisions (when the UE is operating in dual connectivity, carrier aggregation, etc.) are typically taken based on the coverage and quality of a serving cell compared to the quality of a potential neighbour. Quality is typically measured in terms of Reference Signal Received Quality (RSRQ) or signal-to-interference-plus-noise ration (SINR), while coverage is typically measured based on Reference Signal Received Power (RSRP). In NR, a cell may be comprised by a set of beams where PSS/SSS are transmitted in different downlink beams. FIG. 19A illustrates reference signals (Primary Synchronization Signal (PSS), Secondary Synchronization Signal (SSS)) for LTE and FIG. 19B illustrates reference signals for NR.

Beam Level Mobility does not require explicit RRC signaling to be triggered. The gNB provides via RRC signaling the UE with measurement configuration containing configurations of SSB/CSI resources and resource sets, reports and trigger states for triggering channel and interference measurements and reports. Beam Level Mobility is then dealt with at lower layers by means of physical layer and MAC layer control signaling, and RRC is not required to know which beam is being used at a given point in time.

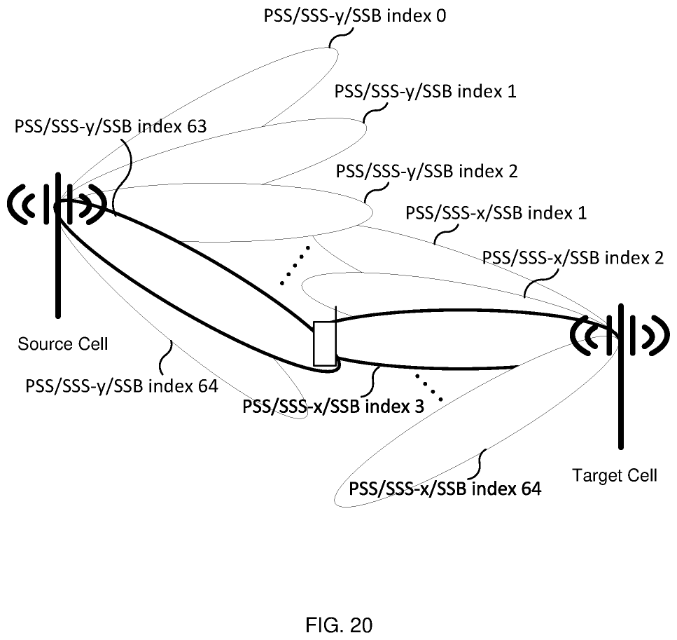

SSB-based Beam Level Mobility is based on the SSB associated with the initial downlink (DL) bandwidth part (BWP) and can only be configured for the initial DL BWPs and for DL BWPs containing the SSB associated with the initial DL BWP. For other DL BWPs, Beam Level Mobility can only be performed based on CSI-RS. FIG. 20 illustrates an example of beam-level handover decision in a NG-RAN system.

Beam measurement information (SSB/CSI-RS indexes with or without associated measurements) may be included in measurement reports. One of the purposes of these beam reports is to enable the source node to take educated decisions in terms of ping-pong avoidance. For example, if multiple neighbour cells are reported (e.g. in an A3 event, namely a mobility event where the trigger condition is that the neighbor cell signal becomes better than the source by a certain offset) and these cells have somewhat equivalent quality/coverage (e.g. similar RSRP and/or similar RSRQ and/or similar RSRQ), criteria to decide where to handover the UE to could be the quality of reported beams. For example, network could prioritize the cells with more beams than another cell.

### 4.6 C-Plane and U-Plane Handling in Handover

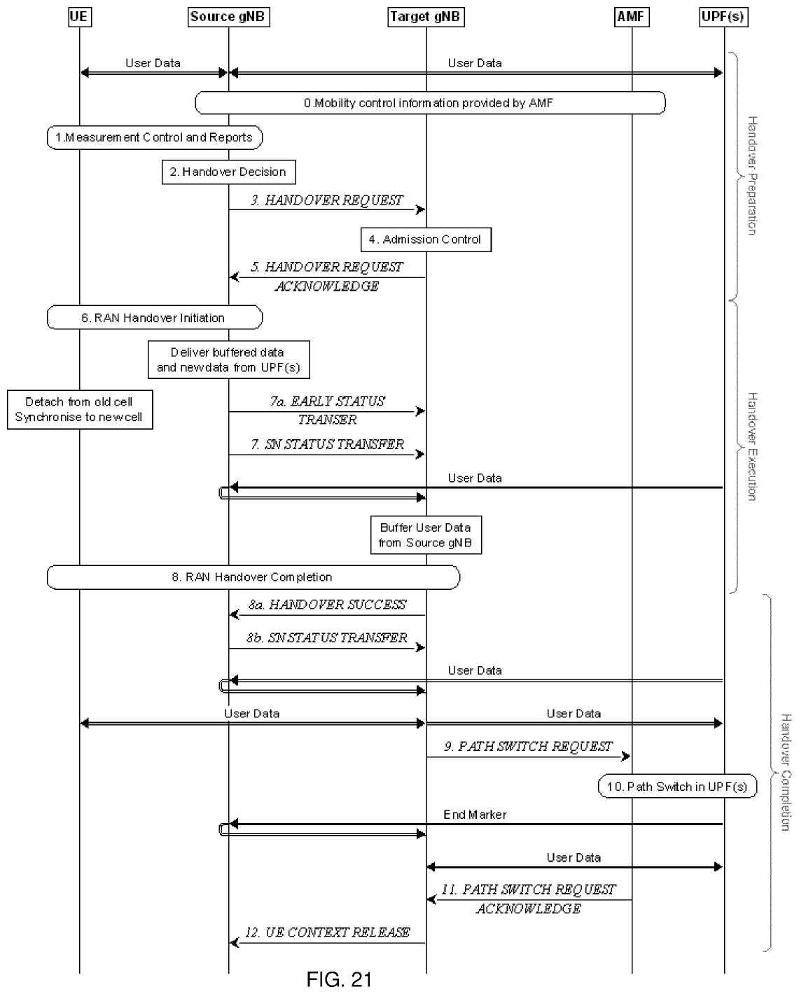

FIG. 21 illustrates the Intra-AMF/UPF Handover for 3GPP NG-RAN system (see Section 9.2.3.2.1 of 3GPP TS 38.300). Upon the handover preparation is completed (steps 1-5), the RAN handover initialization is started (see step 6).

During the RAN handover initialization, from a control plane perspective, the source gNB triggers the handover by sending an RRCReconfiguration message to the UE, containing the information required to access the target cell: at least the target cell ID, the new cell radio network temporary identifier (C-RNTI), the target gNB security algorithm identifiers for the selected security algorithms. It can also include a set of dedicated Random Access Channel (RACH) resources, the association between RACH resources and SSB(s), the association between RACH resources and UE-specific CSI-RS configuration(s), common RACH resources, and system information of the target cell, etc.

The user plane handling during the Intra-NR-Access mobility activity for UEs in RRC_CONNECTED takes the following principles into account to avoid data loss during HO: 1) During HO preparation, U-plane tunnels can be established between the source gNB and the target gNB; 2) During HO execution, user data can be forwarded from the source gNB to the target gNB; and 3) Forwarding should take place in order as long as packets are received at the source gNB from the UPF or the source gNB buffer has not been emptied.

### 5. Network Power, Energy, and Environmental Measurements

Network power, energy, and environmental (PEE) measurements have been standardized, e.g. for NR in TS 28.552 v17.1.0, clause 5.1.1.19 (Power, Energy and Environmental (PEE) measurements), e.g. PNF Power Consumption (average, minimum, maximum), PNF Energy consumption, PNF Temperature (average, minimum, maximum).

### 6. Capacity and Coverage Optimization

As described in 3GPP TR 37.816 v16.0.0, clause 5.1, there are two main use cases for Capacity and Coverage Optimization (CCO).

Use case 1—Coverage problems:

This use case focuses on scenarios where the coverage of reference signals is sub-optimal, leaving the UE exposed to failures or degraded performance, e.g. when a coverage hole is found or where uplink/downlink (UL/DL) disparity is encountered.

It is worth noticing that Mobility Robustness Optimization (MRO) will take care of all types of failures due to wrong mobility settings within a network with good cell planning. That implies that CCO should address cases where the root cause of the problem is due to a bad coverage planning.

Use Case 2—Capacity problems:

Within this class some cases were found where capacity within a cell or beam is saturated, resulting in one or more UEs being subject to failures or suboptimal performance. There are a number of reasons for such event, such as high demand of services which exceeds resources available in the cell/beam or poor radio conditions affecting a large share of served UEs (for example where a large number of UEs is at cell edge, causing high interference to other UEs and consuming large amounts of resources).

It is worth noticing that Mobility Load Balancing (MLB) will take care of load distribution via mobility and that such MLB is done mainly in inter frequency scenarios, i.e. where cross cell interference is not an issue. That implies that CCO should address cases where the root cause of the problem is due to serving UEs at cell/beam edge, where the “edge” is between cells/beams utilizing the same resources.

### Description of Further Embodiments

When attempting to resolve a Capacity and Coverage Optimization (CCO) issue, a first RAN node may update its configuration and send to a second RAN node neighboring the first RAN node information related to the new RAN configuration adopted by the first RAN node. Therefore, there might be interactions between MLB procedures and CCO procedures. As an example, an update of the RAN configuration at the first RAN node, resulting as the outcome of the CCO function, can occur during an ongoing report status update from the first RAN node to a second RAN node. The new configuration of the first RAN node may be different compared to the previous one in different aspects, and this may reflect in the fact that measurements reporting, previously configured for at least one of the cells, or at least one of the SSB beams, or at least one of the S-NSSAIs from one network node to another, may no longer be needed or even valid.

Concerning the coverage provided by a cell or by an SSB beam, the new RAN node configuration may differ from the previous RAN configuration, due to a different shape of at least one cell, or the shape of at least one SSB beam. Another possibility is that the SSB beams realizing the coverage of at least one cell, may have been reorganized in a different manner. Some non-limiting examples are: two or more SSB beams have been merged into one SSB beam, at least one SSB beam has been split in two or more SSB beams, the indexes identifying the SSB beams have been changed, a set of SSB beams have been replaced by a different set of SSB beams, and one or more cells or SSB beams may have been deactivated.

Certain challenges presently exist in that, for example, currently, network nodes do not coordinate with each other with respect to energy savings actions (e.g., an actual energy savings action or a proposed energy savings action). For example, a first network node may modify (or propose modifying) coverage of cells, and/or SSB beam(s), and/or a CSI-RS beam(s) served by the first network node for an energy savings reason (e.g., to reduce energy consumption by the first network node or to increase the energy efficiency of the first network node) and this modification at the first network node may negatively impact end user performance or may deteriorate the energy savings performance of a neighboring network node.

This disclosure additionally provides, among other things, a method for coordination between two network nodes. For example, through a coordination procedure, an energy saving action taken at a first network node (i.e., an action taken by the first network node for an energy savings reason), and impacting the coverage of radio cell(s), SSB beam(s) and/or CSI-RS beam(s) served by a first network node, may result in modifications of radio cell(s), SSB beam(s) and/or CSI-RS beam(s) served by the second network node, enabling the possibility to maintain the end-user performance and to maintain an overall gain in energy savings (e.g., energy efficiency).

The embodiments described herein can apply where the first and second network node uses the same Radio Access Technology (RAT) or they use different RATs (e.g., first network node is an eNB and the second network node is a gNB). When the network nodes use different RATs they may communicate with each other via a core network if necessary.

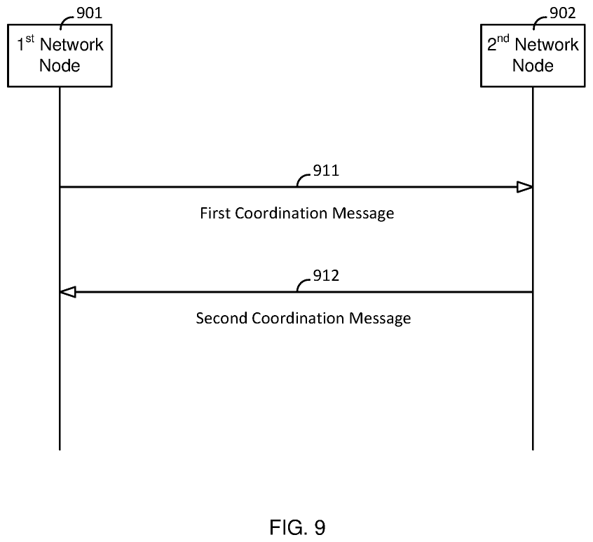

FIG. 9 illustrates a message flow according to embodiment. As illustrated in FIG. 9, a first network node 901 can send a first coordination message 911 to a second network node 902 to indicate to the second network node that one or more cell(s), SSB beam(s) and/or CSI-RS beam(s) served by the first network node is (is being/will be) modified in coverage due to an energy savings reason. The modification can result in that, for one or more cells, SSB beams, and/or CSI-RS beams: (a) the coverage is partially reduced; (b) the coverage is completely removed; (c) the coverage is partially restored; (d) the coverage is completely restored; (e) the coverage is expanded; (f) cell(s)/SSB beam(s)/CSI-RS beam(s) are split; (g) cell(s)/SSB beam(s)/CSI-RS beam(s) are merged; (h) the shape of cell(s)/SSB beam(s)/CSI-RS beam(s) is modified. The modifications taken by the first network node can be done in one step or in multiple steps (e.g., gradually).

The first network node can further use the first coordination message to indicate to the second network node that the first network node is requesting that the second network node modify coverage and/or capacity configuration of at least one cell, SSB beam, and/or CSI-RS beam served by the second network node.

As another embodiment, the first coordination message further includes an energy metric, such as an energy savings value indicating an amount of energy that is expected to be saved or indicating an expected increase in energy efficiency by means of applying the configuration at the first network node indicated by configuration information included in the first coordination message. In this way, the second network node can compare the improvements in energy savings at the first node with the possible deterioration of its own energy savings when applying a configuration that compensates for the first node configuration. Such evaluation may lead to a decision at the second node to either send a reply message indicating that the configuration at the first network node will have a negative impact on performance at the second network node or send a reply message indicating that the configuration at the first network node will not have a negative impact on the performance at the second network node.

The second network node can use the information received in the first coordination message to modify the coverage of at least one cell, SSB beam, and/or CSI-RS beam served by the second network node. The second network node, with the second coordination message, can indicate to the first network node the resulting updated configuration for the second network node.

The second network node can send to the first network node a second coordination message 912 to acknowledge the request.

In one variant, a direct signaling connection exists between the first network node and the second network node (e.g. via XnAP or X2AP). As an example, the first network node is a first gNB and the second network node is a second gNB, and XnAP signaling connection is available between them. The first network node indicates to the second network node that the coverage of a cell(s), SSB beam(s), and/or CSI-RS beam(s) served by the first network node is being modified (e.g., increased or reduced) due to energy savings. The second network node modifies the coverage of SSB beam(s) and/or CSI-RS beam(s) and indicates to the first network node that the node configuration of the second network node is updated.

In another variant, an indirect signaling connection exists between the first network node and the second network node (e.g. via NGAP, S1AP) and at least one third network node is used to transfer the information concerning the actions triggered due to energy savings. As an example, the first network node is a first gNB and the second network node is a second gNB, no XnAP signaling connection is available between them, and one cell, SSB beam, and/or CSI-RS beam served by the first network node is neighboring one cell, SSB beam, and/or CSI-RS beam served by the second network node. In this case, a third network node, that can be a third gNB or an 5G core network (CN) node. The first network node indicates to the second network node, and via the third network node, that the coverage of SSB beam(s) and/or CSI-RS beam(s) served by the first network node is being modified (e.g., increased or reduced) due to energy savings. The second network node modifies the coverage of SSB beam(s) and/or CSI-RS beam(s) and indicates to the first network node, via the third network node, that the node configuration of the second network node is updated.

As another example, the first and second network nodes may utilize two different radio access technologies, e.g. they could be an eNB and a gNB and their mutual connection may be via a core network.

In one embodiment, the second coordination message indicates a negative acknowledgement or a rejection or a failure to adopt one or more (or all) the energy savings actions requested by the first network node in the first coordination message. The second coordination message may indicate that change(s) in cell(s), SSB beams(s), and/or CSI-RS beams(s) configuration at the second network node, and which would compensate for the changes at the first network node and that would enable cell(s), SSB beams(s), and/or CSI-RS beams(s) of second network node to provide coverage to the areas left un-covered by the change(s) in the first network node, is(are) not feasible because this cause an overall deterioration of the energy savings at the second node or because this would cause an overall deterioration of the energy savings in the system made by the first and the second network node. As an alternative, the second coordination message may indicate a failure/reject in accepting the indications/requests sent in the first coordination message due to other reasons (e.g. overload, capacity limitations, etc.).

In one embodiment, as shown in FIG. 9, the first network node sends to the second network node the first coordination message.

In one embodiment, the first coordination message comprises coverage change information indicating actual and/or proposed changes in the coverage of cell(s), SSB beam(s), and/or CSI-RS beam(s) served by the first network node due to the first network node starting or stopping an energy savings action. For example, the coverage change information may comprises: i) first modification information indicating that an actual modification of a coverage for at least one cell and/or at least one beam served by the first network node has occurred for an energy savings reason and/or ii) second modification information indicating a proposed modification of a coverage for at least one cell and/or at least one beam served by the first network node (e.g., wherein the proposed modification is being proposed for an energy savings reason).

In another embodiment the first coordination message comprises information requesting at least one change in the coverage of cell(s), SSB beam(s), and/or CSI-RS beam(s) served by the second network node due to an energy savings action of the first network node and/or due to an energy savings action requested by the first network node to the second network node.

In another embodiment, the first coordination message comprises both the coverage change information and the information requesting at least one change.

For instance, in one embodiment, the first coordination message comprises:
i) first modification information indicating that an actual modification of a coverage for at least one cell and/or at least one beam served by the first network node has occurred for an energy savings reason, and/or
ii) second modification information indicating a proposed modification of a coverage for at least one cell and/or at least one beam served by the first network node (e.g., the proposed modification is being proposed for an energy savings reason), and/or
iii) third modification information indicating a proposed modification of a coverage for at least one cell and/or at least one beam served by the second network node (e.g., the proposed modification is being proposed for an energy savings reason).

In one embodiment, if the first coordination message includes the first modification information indicating that an actual modification has occurred, then: i) the actual modification that has occurred is not a deactivation of the cell, and/or ii) the first coordination message further comprise an energy metric associated with the coverage modification indicated by the first modification information, and/or iii) the first coordination message further comprises the second and/or the third modification information.

In one embodiment, if the first coordination message includes the third modification information, then: i) the first coordination message indicates that a reason for the proposed modification of the coverage is an energy saving reason, and/or ii) the first coordination message further comprises an energy metric associated with the coverage modification indicated by the third modification information, and/r iii) the first coordination message further comprises the first and/or second modification information.

In one embodiment, if the first coordination message includes the second modification information, then: i) the first coordination message indicates that a reason for the proposed modification of the coverage is an energy saving reason, and/or ii) the first coordination message further comprises an energy metric associated with the coverage modification indicated by the second modification information, and/or iii) the first coordination message further comprises the first and/or third modification information.

In one embodiment, the first coordination message may further indicate that energy savings action: i) has already been executed, ii) is in the process of being executed, iii) may be executed, or iv) will be executed by the first network node.

The first coordination message can contain at least one of the following indications of an energy savings action (applied to cells, SSB beams, and/or CSI-RS beams) associated to the first network node:
a partial coverage reduction;
a complete coverage removal;
a partial coverage restore;
a complete coverage restore;
a coverage expansion;
a split;
a merge;
a change in shape
the coverage modification can be obtained immediately or gradually
at least one cell and/or SSB beam and/or CSI-RS beam of the first network node has been (or is being, or will be) taken out of service or in service
at least one cell and/or SSB beam and/or CSI-RS beam of the first network node has been (or is being) taken (back) into service
the coverage of at least one cell and/or SSB beam and/or CSI-RS beam of the first network node has been (or is being/will be) modified, e.g. reduced or increased.
the coverage of at least one cell and/or SSB beam and/or CSI-RS beam of the first network node which has been (or is being) recovered
an indication, indicating if the action at the first network node has immediate effect or is being executed gracefully
   in case of graceful action, the pace at which the action is done (e.g. the reductions or increment in coverage in dB/sec)
a planned or expected or residual duration of the action at the first network node
a modification (e.g., a reduction or an increase) of the downlink transmission power of at least a reference signal transmitted by the first network node in at least one of the serving cells. Non-limiting examples of reference signals may include cell-specific reference signal, SSB beams, CSI-RS beams of the first network node
A modification (e.g., a reduction or an increase) of the downlink transmission power of at least physical downlink control channel or a physical downlink shared data channel. Non-limiting examples of such channels comprise PDCCH, ePDCCH, PDSCH, etc.
An antenna tilt adjustment associated to at least a serving cell of the first network node
Physical layer adjustments, e.g.
   a modified time division duplex (TDD) configuration associated to at least a serving cell of the first network node
   a modified sub-carrier spacing configuration associated to at least a serving cell of the first network node. The modification may be applicable to the data and/or control channels.
   a modified MIMO configuration
   a modified Bandwidth
An indication of the estimated energy decrease or increase in the first node as a result of the planned action
cell(s), SSB beam(s), and/or CSI-RS beam(s) of the second network node that are expected to be impacted by energy savings actions at the first network node

In one embodiment, the energy savings action requested by the first network node to the second network node with the information included in the first coordination message may indicate to modify coverage and/or capacity configuration of at least one cell, SSB beam, and/or CSI-RS beam of the second network node. The requested action can be one or more in the group of:
activating or deactivating a cell of the second network node
modifying coverage or capacity of one or more cells, SSB beams, and/or CSI-RS beams of the second network node
modifying antenna configuration for one or more cells of the second network node, such as scaling/changing the active array size, modifying the antenna tilt angle (horizontal and/or vertical direction)
modifying one or more physical layer configuration parameters for at least a cell of the second network node (e.g. Bandwidth adaptation, subcarrier spacing, TDD pattern)
modifying transmission power (e.g., increasing transmission power to increase coverage)
modifying (e.g., a reducing or increasing) the downlink transmission power of at least physical downlink control channel or a physical downlink shared data channel. Non-limiting examples of such channels comprise PDCCH, ePDCCH, PDSCH, etc

As another embodiment, the first coordination message further includes an energy metric indicating how much energy consumption/efficiency is expected to improve at the first network node by means of applying the configuration at the first network node comprised in the first coordination message. In this way, the second node can compare the improvements in energy savings at the first node with the possible deterioration of its own energy savings when applying a second node configuration that compensates for the first node configuration. Such evaluation may lead to a decision at the second node to either send a reply message stating that the second node configuration is feasible or stating that such configuration is not feasible, due to energy savings reasons.

In another embodiment, the second coordination message acknowledges the first coordination message and can comprise: a second configuration of the second network node, and information of the change(s) in cell/SSB Area/CSI RS area configurations due to energy savings reasons and/or indications of which cell(s), SSB beam(s), and/or CSI-RS beam(s) of the second network node are affected by energy saving actions started by the first network node.

In an embodiment in which the first coordination message includes the information requesting at least one change as described above, the second coordination message may include information indicating that the second network node will perform one or more of the actions requested by the first network node. In this case, the second coordination message may additionally comprise configuration information generated by the second network node and indicating one or more of:
change(s) in cell(s)/SSB Area(s)/CSI-RS area(s) configurations of the second network node due the action for energy savings requested by the first network node
indications of which cell(s), SSB beam(s), and/or CSI-RS beam(s) of the second network node are affected by energy savings actions requested by the first network node
An indication of one or more energy savings actions requested by the first network node that are adopted (e.g., started, planned to be started) by the second network node.
An indication of one or more energy savings actions requested by the first network node that are not adopted by the second network node.
An indication of a starting time and/or a time window indicating the validity (e.g., starting time and/or duration) of one or more actions or configurations adopted by the second network node as indicated in the second coordination message.

An indication of at least one energy metrics related to the second network node and an associated impact (actual or predicted) due to acknowledging the requests/indications received in the first coordination message.

In another embodiment, the second coordination message may indicate a failure—i.e., the second coordination message may indicate that change(s) in the configuration of a cell, SSB beam, and/or CSI-RS at the second node which would compensate for the changes at the first network node (e.g., the changes in the configuration of the cell(s), SSB beams(s), and/or CSI-RS beams(s) of second network node will provide coverage to the areas left un-covered by the change(s) in the first network node) is (are) not feasible because this causes an overall deterioration of the energy savings at the second node or because this would cause an overall deterioration of the energy savings in the system made by the first and the second network node. As an alternative, the second coordination message may indicate a failure due to other reasons (e.g. overload, capacity limitations, etc.).

In an embodiment in which the first coordination message includes the above described information requesting at least one change, the second coordination message transmitted by the second network node in response to the first coordination message indicates a negative acknowledgement (NACK) or a rejection or a failure to adopt one or more (or all) actions requested by the first network node to the second network. The second coordination message may additionally comprise one or more causes associated to the NACK or the rejection or the failure (or all) energy savings actions requested by the first network node to the second network.

In one embodiment, the first coordination message can be implemented as a “NG-RAN NODE configuration UPDATE” XnAP message and the “second coordination message” can be implemented as either “NG-RAN NODE configuration UPDATE ACKNOWLEDGE” XnAP message or “NG-RAN NODE configuration UPDATE FAILURE” XnAP message.

In one embodiment, the second network node receives from the first network node the first coordination message, wherein the first coordination message may: (1) indicate changes in the coverage of cell(s), SSB beam(s), and/or CSI-RS beam(s) served by the first network node, due to the first network node starting or stopping an energy savings action (e.g., an energy savings action), and/or (2) request changes in the coverage of cell(s), SSB beam(s), and/or CSI-RS beam(s) served by the second network node due to an energy savings action of the first network node and/or due to an energy savings action requested by the first network node to the second network node. That is, the first coordination message can contain the indications as described above with respect to the embodiments for the first network node.

In another embodiment, the second network node determines a second configuration of cell(s), SSB beam(s), and/or CSI-RS beam(s) of the second network node due to energy saving actions started or planned by the first network node. Such configuration may serve the purpose of compensating for the coverage gap left by the modified configuration adopted by the first network node due to energy savings reasons.

Additionally, the second network node may determine the actual/estimated energy impact of adopting the second configuration of cell(s), SSB beam(s), and/or CSI-RS beam(s) at the second network node due to the energy saving actions started or planned by the first network node.

In one embodiment, the second network node may determine an actual/estimated impact on energy savings at the second network node based on indications provided by the first network node and related to: (i) identities of the cell(s), SSB beam(s), and/or CSI-RS beam(s) of the second network node, that are expected to be impacted by energy savings actions at the first network node; (ii) configuration aspects of the cell(s), SSB beam(s), and/or CSI-RS beam(s) of the second network node, that are expected to be impacted by energy savings actions at the first network node (e.g. if a cell is operating in Frequency Range 1 or Frequency Range 2); and/or (iii) the current status of the cell(s), SSB beam(s), and/or CSI-RS beam(s) of the second network node (e.g. some cells may be inactive and to compensate for energy savings actions at the first network node they would need to be reactivated).

As another embodiment, the first coordination message comprises indications pertaining to energy metrics, e.g. indicating how much energy consumption/efficiency is expected to improve by means of applying the configuration at the first network node comprised in the first coordination message. The second node can use the said indications to perform at least one of the following: (i) comparing the improvements in energy savings at the first node with the possible deterioration in energy savings at the second network node; (ii) evaluating/determining if a second node configuration is applicable that compensates for the modified configuration at the first network node; (iii) applying a second node configuration, if applicable; and/or (iv) sending to the first network node the second coordination message that can comprise an indication indicating that the request is feasible or not, and the determined second node configuration.

In another embodiment, the second coordination message includes information pertaining to the second configuration of the second network node, and comprising information concerning cell(s), SSB beam(s), and/or CSI-RS beam(s) of the second network node due to energy saving actions started by the first network node. The response message may also include an indication of at least one energy metrics (e.g., a value indicating an amount of energy saved) related to the second network node and an associated impact (actual or predicted) due to acknowledging the requests/indications received in the first coordination message.

The second coordination message may indicate a failure and may include an indication that change(s) in cell(s), SSB beams(s), and/or CSI-RS beams(s) configuration at the second node, which would compensate for the changes at the first network node (e.g., that would enable cell(s), SSB beams(s), and/or CSI-RS beams(s) of second network node to provide coverage to the areas left un-covered by the change in the first network node) is not feasible because this cause an overall deterioration of the energy savings at the second node or because this would cause an overall deterioration of the energy savings in the system made by the first and the second network node. In some scenarios, the second coordination message indicates a failure due to other reasons (e.g. overload, capacity limitations, etc.).

An example implementation is provided below for with respect to XnAP (see 3GPP TS 38.423). Specifically, in one embodiment, the “Served Cells To Update NR” information element (IE), which currently is defined to contain updated configuration information for served NR cells exchanged between NG-RAN nodes, is extended to further include the following IEs: i) SSB Area Activation Indication List, ii) SSB Area Activation Indication Item, iii) SSB Index, iv) SSB Area Activation State, and v) SSB Coverage State, as shown in the table below.

| | | | IE type and | Semantics | | Assigned |
|---|---|---|---|---|---|---|
| IE/Group Name | Presence | Range | reference | description | Criticality | Criticality |
| Served Cells NR To | | 0 . . . < | | List of added | GLOBAL | reject |
| Add | | maxnoof- | | cells served by | | |
| | | CellsinNG- | | the NG-RAN | | |
| | | RAN node> | | node. | | |
| >Served Cell | M | | 9.2.2.11 | | — | |
| Information NR | | | | | | |
| >Neighbour | O | | 9.2.2.13 | | — | |
| Information NR | | | | | | |
| >Neighbour | O | | 9.2.2.14 | | — | |
| Information E- | | | | | | |
| UTRA | | | | | | |
| Served Cells To | | 0 . . . < | | List of modified | YES | reject |
| Modify NR | | maxnoof- | | cells served by | | |
| | | CellsinNG- | | the NG-RAN | | |
| | | RAN node> | | node. | | |
| >Old NR CGI | M | | NR CGI | | — | |
| | | | 9.2.2.7 | | | |
| >Served Cell | M | | 9.2.2.11 | | — | |
| Information NR | | | | | | |
| >Neighbour | O | | 9.2.2.13 | | — | |
| Information NR | | | | | | |
| >Neighbour | O | | 9.2.2.14 | | — | |
| Information E- | | | | | | |
| UTRA | | | | | | |
| >Deactivation | O | | ENUMERATED | Indicates that | — | |
| Indication | | | (deactivated, | the concerned | | |
| | | | . . . ) | cell is switched | | |
| | | | | off for energy | | |
| | | | | saving reasons. | | |
| >>SSB Area | O | | | | YES | ignore |
| Activation Indication | | | | | | |
| List | | | | | | |
| >>> SSB Area | | 1 . . . < max- | | | | |
| Activation Indication | | noofSSBA- | | | | |
| Item | | reas> | | | | |
| >>>> SSB Index | O | | INTEGER | | — | |
| | | | (0 . . . 63) | | | |
| >>>> SSB Area | O | | ENUMERATED | Indicates if the | — | |
| Activation State | | | (deactivated | concerned SSB | | |
| | | | activated, . . . ) | Area is | | |
| | | | | deactivated at | | |
| | | | | start of energy | | |
| | | | | saving or | | |
| | | | | activated at | | |
| | | | | stop of energy | | |
| | | | | saving | | |
| >>>> SSB | O | | INTEGER | Indicates that | — | |
| Coverage State | | | (1 . . . 32, . . . ) | the SSB is | | |
| | | | | active and also | | |
| | | | | indicates the | | |
| | | | | coverage | | |
| | | | | configuration of | | |
| | | | | the concerned | | |
| | | | | SSB | | |
| Served Cells To | | 0 . . . < | | List of deleted | YES | reject |
| Delete NR | | maxnooff- | | cells served by | | |
| | | CellsinNG- | | the NG-RAN | | |
| | | RAN node > | | node. | | |
| >Old NR-CGI | M | | NR CGI | | — | |
| | | | 9.2.2.7 | | | |

| Range bound | Explanation |
|---|---|
| maxnoofCellsinNG- | Maximum no. cells that can be served by a |
| RAN node | NG-RAN node. Value is 16384. |
| maxnoofSSBAreas | Maximum no. SSB Areas that can be served by a |
| | NG-RAN node cell. Value is 64. |

Accordingly, in one embodiment the first network node transmits the first coordination message to the second network node by transmitting to the second network node a “NG-RAN NODE CONFIGURATION UPDATE” message that includes a Served Cells To Update NR IE that includes at least one SSB Index IE that identifies an SSB area and the associated SSB Area Activation IE that indicates if the concerned SSB Area is deactivated at start of energy saving or activated at stop of energy saving.

This section describes some non-limiting examples of the first and second network nodes.

In one embodiment, the first network node is a first RAN node (e.g. a gNB or an eNB) and a second network node is a second RAN node (e.g. another gNB or another eNB) and the communication between the first network node and the second network node can occur directly or indirectly (e.g. via XnAP, X2AP) or via a third network node (e.g. NGAP, S1AP).

In one example, the first network node and the second network node are enhanced NodeBs of 3GPP E-UTRAN system. In this case, the first coordination message and the second coordination message can be exchanged using a X2 interface of the E-UTRAN system (e.g., LTE and/or LTE-A).

In another example, the first network node and the second network node are NG-RAN nodes (e.g., gNB) of a 3GPP NG-RAN system (also knowns as NR system). In this case the first coordination message and the second coordination message can be exchanged using a Xn interface of the NG-RAN system.

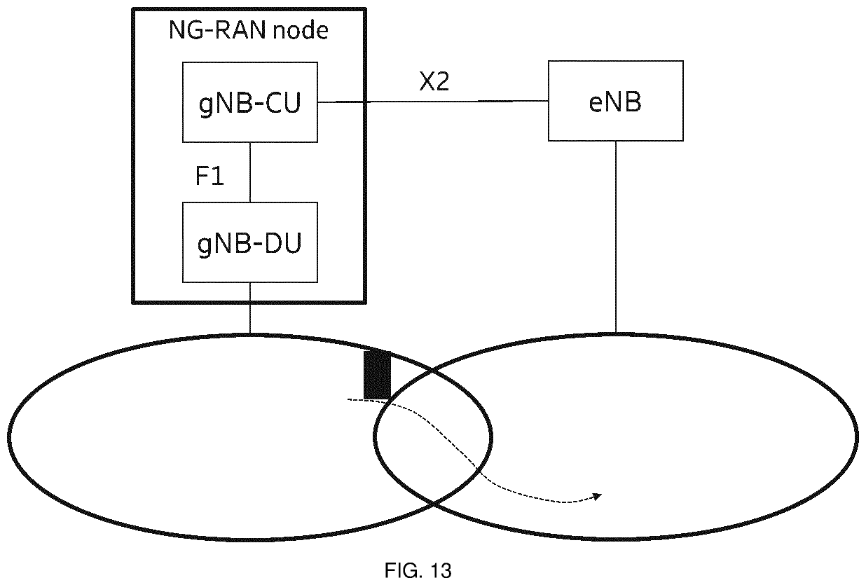

In another example, the first network node is an NG-RAN node of an NG-RAN system, while the second network node is enhanced NodeB (i.e., eNB or en-eNG) of an E-UTRAN system. In this case, the first coordination message and the second coordination message can be exchanged using a X2 interface between the E-UTRAN system and NG-RAN system: without loss of generality, the first network node could be a RAN node or a logical node of a RAN node, such as a gNB-CU, as illustrated in FIG. 13.

In one embodiment with distributed architecture, a first network node is a first logical entity of a RAN node and the second network node is a second logical entity of a RAN node. In one scenario, the first network node and the second network node can be two different logical entities of the same RAN node. In another scenario, the first network node and the second network node are two logical entities of two different RAN nodes. Examples of logical entities of a RAN node are, for in instance, the centralized unit (CU) of an NG-RAN node (e.g., a gNB-CU or the relative control plane node gNB-CU-CP) and the distributed unit (DU) of an NG-RAN node (e.g., a gNB-DU). Additionally, if present, a third network node is a third logical entity of a RAN node (e.g. a second gNB-DU).

In one embodiment, the first network node is a distributed unit (DU) of an NG-RAN node (e.g., a gNB-DU), while the second network node is a centralized unit (CU) of an NG-RAN node (e.g., a gNB-CU or a gNB-CU-CP). In this case, the first coordination message and the second coordination message can be exchanged using a F1 interface of the NG-RAN system, as illustrated in FIG. 10.

In one embodiment, the first network node is a first centralized unit (CU) of a NG-RAN node (e.g., a gNB-CU), while the second network node is a second decentralized unit (DU) of a NG-RAN node (e.g., a gNB-CU). In this case, the first coordination message and the second coordination message can be exchanged using a F1 interface of the NG-RAN system.

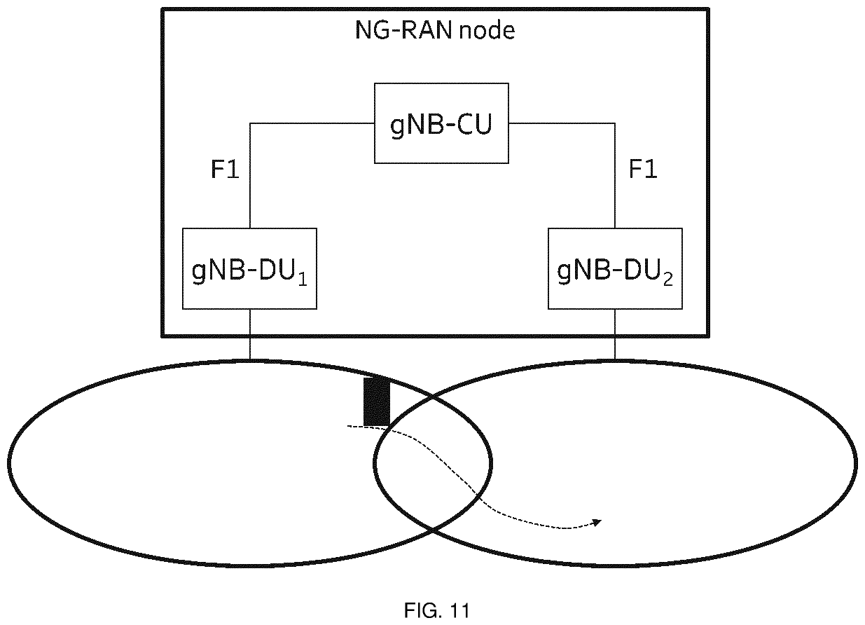

FIG. 11 illustrates how one or more of the embodiments can be applied. In this example, an NG-RAN node consists of three or more logical nodes comprising multiple distributed units (i.e., multiple gNB-DUs) controlled by a single centralized unit (i.e., a gNB-CU). Thereby, one embodiment can be applied to pairs of nodes in a system with nodes to coordinate the configuration. In this example, two gNB-DUs coordinate via a gNB-CU (or the gNB-CU-CP). The method is thereby applied between the gNB-DU₁ and the gNB-CU, with communication over a F1 interface and between the gNB-CU and the gNB-DU₂, with communication over a F1 interface.

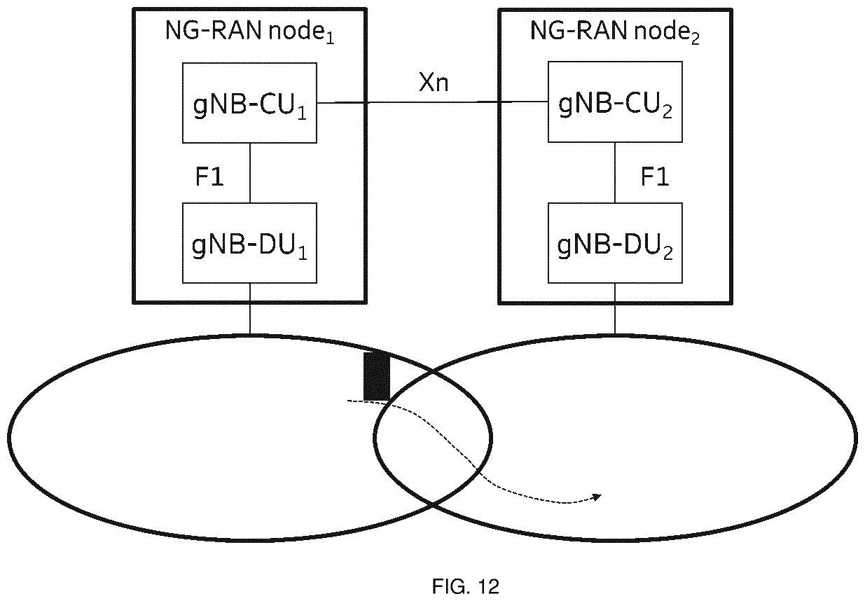

In one embodiment, the first network node is a first centralized unit (CU) of a first NG-RAN node (e.g., a gNB-CU₁), while the second network node is a second centralized unit (CU) of a second NG-RAN node (e.g., a gNB-CU₂). In this case, the first coordination message and the second coordination message can be exchanged using a Xn interface of the NG-RAN system, as illustrated in FIG. 12.

FIG. 12 further illustrates how one or more of the embodiments can be applied by different distributed units (DUs) belonging to two different NG-RAN nodes with split architecture. In this example, two gNB-DUs belonging to two different NG-RAN nodes coordinate via the respective centralized units, i.e. gNB-CU₁ and gNB-CU₂ (or the gNB-CU₁-CP and the gNB-CU₂-CP) respectively. The method is thereby applied: between the gNB-DU₁ and the gNB-CU₁, with communication over a F1 interface; between the gNB-CU₁ and the gNB-CU₂, with communication over a Xn interface; and between the gNB-CU₂ and the gNB-DU₂, with communication over a F1 interface.

FIG. 13 illustrates how one or more of the embodiments can be applied between radio cells controlled by a NG-RAN nodes with split architecture and an eNB. In this example, a gNB-DU belonging to the NG-RAN node coordinates via its centralized unit, i.e. gNB-CU (or the gNB-CU-CP), with a eNB. The embodiments are thereby applied between the gNB-DU and the gNB-CU, with communication over a F1 interface and between the gNB-CU and the eNB, with communication over a X2 interface.

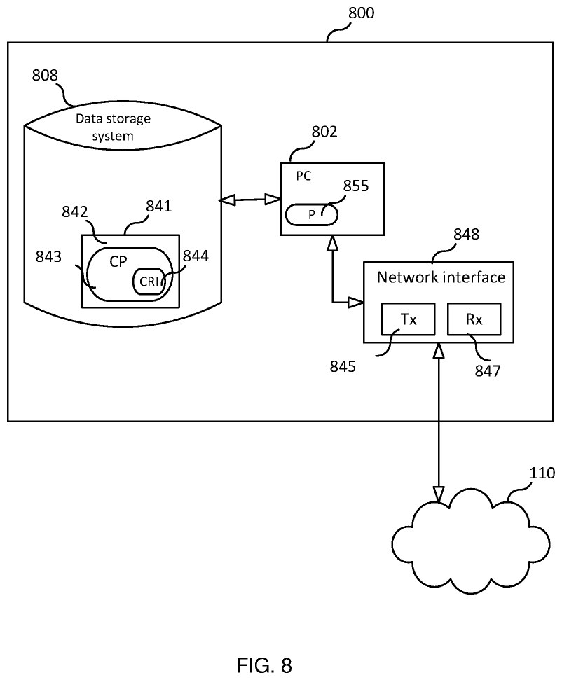

FIG. 8 is a block diagram of an apparatus, according to some embodiments, for performing the methods disclosed herein (e.g., the first or second network node may be implemented using network node apparatus 800). In some embodiments, network node apparatus 800 may correspond to gNB 100A or 100B as shown in FIG. 1. As shown in FIG. 8, network node apparatus 800 may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 800 may be a distributed computing apparatus); at least one network interface 848 comprising a transmitter (Tx) 845 and a receiver (Rx) 847 for enabling apparatus 800 to transmit data to and receive data from other nodes connected to a network 110 (e.g., an Internet Protocol (IP) network or NG RAN) to which network interface 848 is connected (directly or indirectly) (e.g., network interface 848 may be wirelessly connected to the network 110, in which case network interface 848 is connected to an antenna arrangement); and a storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes network node apparatus 800 to perform steps described herein (e.g., steps described herein with reference to the flow charts). In other embodiments, network node apparatus 800 may be configured to perform steps described herein without the need for code. That is, for example, PC 802 may consist merely of one or more ASICs. Hence, the features of the embodiments described herein may be implemented in hardware and/or software.

According to embodiments, a central node, as referred to herein, may be implemented as a physical or virtual node, and may be implemented as a physical or virtual node in a computing device or server apparatus and/or in a virtualized environment, for example in a cloud, edge cloud or fog deployment. The central node may be implemented to provide a dedicated service, such as for example implementing a machine learning model, or be implemented as part of a RAN or CN node.

### Summary of Various Embodiments

A1. A method performed by a first network node (100A, 800) for coordinating with a second network node (100B, 800) with respect to an energy metric, the method comprising: the first network node determining or identifying (s602) based on the energy metric at least one of: (i) an action to perform or (ii) a request relating to the second network node; the first network node generating (s604) a first message, the first message comprising an indication that the action or the request is due to an energy saving reason; and the first network node transmitting (s606) the first message towards the second network node.

A2. The method of embodiment A1, further comprising: the first network node receiving a second message (403A-C) transmitted by the second network node, the second message comprising a response to the first message.

A3. The method of any one of embodiments A1-A2, wherein the action to perform comprises one or more of: an offloading of network traffic to the second network node, a handover of one or more user equipments (UEs) to the second network node, an adjustment of one or more mobility parameters, a reduction of load at the first network node, a reduction in capacity at the first network node, an adjustment in a sleep mode state at the first network node, a reduction of one or more processing resources at the first network node, or an adjustment to a downlink transmission cycle.

A4. The method of any one of embodiments A1-A3, wherein the indication indicates one or more of the following: a handover is desired due to the energy saving reason, network node power saving, the action is desired because of an energy saving reason, a cell and/or reference signal beam (e.g., SSB beam or CSI-RS beam) are or will not be available for energy saving reasons, or a cell and/or reference signal beam (or just “beam” for short) deactivation is desired or planned due to energy saving reasons.

A5. The method of any one of embodiments A1-A4, wherein the first message further comprises one or more of: an indication of an amount of load being transferred from the first network node to the second network node, or a request for the second network node to update a capacity of at least one cell or reference signal beam of the second network node.

A6. The method of any one of embodiments A1-A5, wherein first the message further comprises one or more of: an indication of an amount or percentage of load to be offloaded from a cell or reference signal beam of the first network node in order to deactivate the cell or reference signal beam, an indication of an amount or percentage of load to be offloaded from a cell or reference signal beam of the first network node in order to reach the energy metric, an amount or percentage of load for a cell or reference signal beam of the first network node for which the energy metric is met, a cell global identity (CGI) of at least one cell of the first network node to be deactivated based on the energy metric, a CGI of at least one cell of the first network node for which the energy efficiency metric is to be enhanced, an indication of an implication of the action or the request on the energy metric, or a time interval within which the first network node is planning to transfer traffic to the second network node.

A7. The method of any one of embodiments A1-A6, wherein the first message is a handover request message, wherein the handover request message comprises a field comprising the indication.

A8. The method of any one of embodiments A1-A7, wherein the first message is a mobility change request message, wherein the mobility change request message comprises a field comprising the indication.

A9. The method of any one of embodiments A1-A8, wherein the first message comprises an indication of an amount of load to be offloaded from the first network node the second network node.

A10. The method of embodiment A9, wherein the indication of the amount of load to be offloaded comprises one or more of: a total radio resource usage, a data volume, a total or average throughput, a number of radio resource control (RRC) connections, a number of active user equipments (UEs), one or more radio conditions of UEs to be offloaded and/or a geographical location, a served QoS flow, a total amount of GBR and non GBR resources to be offloaded, a load information specified on a per network slice basis, a value corresponding to an energy metric, a time interval within which the first network node is planning to transfer traffic to the second network node, or a UE type to be offloaded.

A11. The methods any one of embodiments A1-A10, wherein the second message comprises one or more of: a failure message if the action or the request cannot be initiated, a rejection message if the action or the request cannot be accepted, an accept or acknowledgement message indicating that the action or the request can be accepted, or information comprising an alternative proposal to the action or the request.

A12. The method of any one of embodiments A1-A11, wherein the first message comprises information indicating a policy for the first or second network node relating to the energy metric.

A13. The method of embodiment A12, wherein the policy for the first network node relating to the energy metric comprises one or more of: a specified mode relating to power consumption, a preferred energy consumption state, a preferred load state, an indication of deactivation or activation of energy saving functionality, or a margin for acceptable energy consumption increase.

A14. The method of any one of embodiments A1-A13, wherein the first message comprises information indicating one or more validity criteria relating to the energy metric.

A15. The method of embodiment A14, further comprising: the first network node obtaining the validity criteria, wherein the validity criteria is configured by a third network node.

A16. The method of embodiment A14 or A15, wherein the validity criteria comprises one or more of: an operator constraint indicating a time period during which load transfer due to energy efficiency is not desirable, an operator constraint connected to a specific performance indicator, an operator constraint connected to specific services, a constraint on a cell or SSB level, indicating that at least one cell or at least one SSB shall, should, or cannot be considered for energy saving related decisions, an activation or deactivation of energy saving function in combination with aspects concerning an air interface transmission/reception that can impact energy consumption of more than one cell or more than one transmission point at same time, a possibility of coexistence of energy saving opportunities with functionalities concerning duplication of packet transmission/reception to ensure high reliability, an activation or deactivation of an energy saving function based on QoE related indication, or an activation or deactivation of energy saving function based on temperature indication.

A17. The method of any one of embodiments A1-A16, the method further comprising: the first network node providing, to a machine learning model, input based on the response to the first message and further comprising an indication of the action or the request; and the first network node obtaining an output generated by the machine learning model, the output comprising an indication of the impact of the action or the request on a key performance indicator (KPI) metric for a user equipment.

A18. The method of embodiment A17, wherein the machine learning model is implemented in the first network node.

A19. The method of embodiment A17, wherein the machine learning model is implemented in a central node, and wherein: the providing comprises the first network node transmitting the input towards the central node; and the obtaining comprises receiving the output transmitted by the central node.

A20. A first network node (100A, 800) in a radio access network (110) configured to: determine or identify (s602) based on an energy metric at least one of: (i) an action to perform or (ii) a request relating to the second network node; generate (s604) a first message, the first message comprising an indication that the action or the request is due to an energy saving reason; and transmit (s606) the first message towards the second network node.

A21. The network node of embodiment A20, further adapted to perform any one of methods A1-A19.

A22. A computer program (843) comprising instructions (841) which when executed by processing circuitry (855) of a first network node (100A, 800) causes the first network node to perform the method of any one of methods A1-A19.

A23. A carrier containing the computer program of embodiment A22, wherein the carrier is one of an electronic signal, an optical signal, a radio signal, and a computer readable storage medium (842).

B1. A method performed by a second network node (110B, 800) for coordinating with a first network node (110A, 800) with respect to an energy metric, the method comprising: the second network node receiving (s702) a first message transmitted by the first network node, the first message comprising a request comprising an indication that an action to be performed or a request relating to the second network node is associated with the energy metric; and the second network node transmitting (s704) a second message towards the first network node, the second message comprising a response to the first message.

B2. The method of embodiment B1, wherein the action to perform comprises one or more of: an offloading of network traffic to the second network node, a handover of one or more user equipments (UEs) to the second network node, an adjustment of one or more mobility parameters, a reduction of load at the first network node, a reduction in capacity at the first network node, an adjustment in a sleep mode state at the first network node, a reduction of one or more processing resources at the first network node, or an adjustment to a downlink transmission cycle.

B3. The method of any one of embodiments B1-B2, wherein the indication indicates one or more of the following: a handover is desired due to the energy saving reason, network node power saving, the action is desired because of an energy saving reason, a cell and/or reference signal beam are or will not be available for energy saving reasons, or a cell and/or reference signal beam deactivation is desired or planned due to energy saving reasons.

B4. The method of any one of embodiments B1-B3, wherein the first message further comprises one or more of: an indication of an amount of load being transferred from the first network node to the second network node, or a request for the second network node to update a capacity of at least one cell or reference signal beam of the second network node.

B5. The method of any one of embodiments B1-B4, wherein the first message further comprises one or more of: an indication of an amount or percentage of load to be offloaded from a cell or reference signal beam of the first network node in order to deactivate the cell or reference signal beam, an indication of an amount or percentage of load to be offloaded from a cell or reference signal beam of the first network node in order to reach the energy metric, an amount or percentage of load for a cell or reference signal beam of the first network node for which the energy metric is met, a cell global identity (CGI) of at least one cell of the first network node to be deactivated based on the energy metric, a CGI of at least one cell of the first network node for which the energy efficiency metric is to be enhanced, an indication of an implication of the action or the request on the energy metric, or a time interval within which the first network node is planning to transfer traffic to the second network node.

B6. The method of any one of embodiments B1-B5, wherein the first message is a handover request message, wherein the handover request message comprises a field comprising the indication.

B7. The method of any one of embodiments B1-B6, wherein the first message is a mobility change request message, wherein the mobility change request message comprises a field comprising the indication.

B8. The method of any one of embodiments B1-B7, wherein the first message comprises an indication of an amount of load to be offloaded from the first network node the second network node.

B9. The method of embodiment B8, wherein the indication of the amount of load to be offloaded comprises one or more of: a total radio resource usage, a data volume, a total or average throughput, a number of radio resource control (RRC) connections, a number of active user equipments (UEs), one or more radio conditions of UEs to be offloaded and/or a geographical location, a served QoS flow, a total amount of GBR and non GBR resources to be offloaded, a load information specified on a per network slice basis, a value corresponding to an energy metric, a time interval within which the first network node is planning to transfer traffic to the second network node, or a UE type to be offloaded.

B10. The methods any one of embodiments B1-B9, wherein the second message comprises one or more of: a failure message if the action or the request cannot be initiated, a rejection message if the action or the request cannot be accepted, an accept or acknowledgement message indicating that the action or the request can be accepted, or information comprising an alternative proposal to the action or the request.

B11. The method of any one of embodiments B1-B10, wherein the first message comprises information indicating a policy for the first or second network node relating to the energy metric.

B12. The method of embodiment B11, wherein the policy for the first network node relating to the energy metric comprises one or more of: a specified mode relating to power consumption, a preferred energy consumption state, a preferred load state, an indication of deactivation or activation of energy saving functionality, or a margin for acceptable energy consumption increase.

B13. The method of any one of embodiments B1-B12, wherein the first message comprises information indicating one or more validity criteria relating to the energy metric.

B14. The method of embodiment B13, further comprising: the first network node obtaining the validity criteria, wherein the validity criteria is configured by a third network node.

B15. The method of embodiment B13 or B14, wherein the validity criteria comprises one or more of: an operator constraint indicating a time period during which load transfer due to energy efficiency is not desirable, an operator constraint connected to a specific performance indicator, an operator constraint connected to specific services, a constraint on a cell or SSB level, indicating that at least one cell or at least one SSB shall, should, or cannot be considered for energy saving related decisions, an activation or deactivation of energy saving function in combination with aspects concerning an air interface transmission/reception that can impact energy consumption of more than one cell or more than one transmission point at same time, a possibility of coexistence of energy saving opportunities with functionalities concerning duplication of packet transmission/reception to ensure high reliability, an activation or deactivation of an energy saving function based on QoE related indication, or an activation or deactivation of energy saving function based on temperature indication.

B16. The method of any one of embodiments B1-B15, the method further comprising: the second network node providing, to a machine learning model, input based on the first message and further comprising an indication of the action or the request; and the second network node obtaining an output generated by the machine learning model, the output comprising an indication of the impact of the action or the request on a key performance indicator (KPI) metric for a user equipment.

B17. The method of embodiment B16, wherein the machine learning model is implemented in the second network node.

B18. The method of embodiment B17, wherein the machine learning model is implemented in a central node, and wherein: the providing comprises the second network node transmitting the input towards the central node; and the obtaining comprises receiving the output transmitted by the central node.

B19. A second network node (100B, 800) in a radio access network (110) configured to: receive (s702) a first message transmitted by the first network node, the first message comprising a request comprising an indication that an action to be performed or a request relating to the second network node is associated with an energy metric; and transmit (s704) a second message towards the first network node, the second message comprising a response to the first message.

B20. The second network node of embodiment B19, further adapted to perform any one of methods B1-B18.

B21. A computer program (843) comprising instructions (844) which when executed by processing circuitry (855) of a second network node (100B, 800) causes the second network node to perform the method of any one of methods B1-B18.

B22. A carrier containing the computer program of embodiment B21, wherein the carrier is one of an electronic signal, an optical signal, a radio signal, and a computer readable storage medium (842).

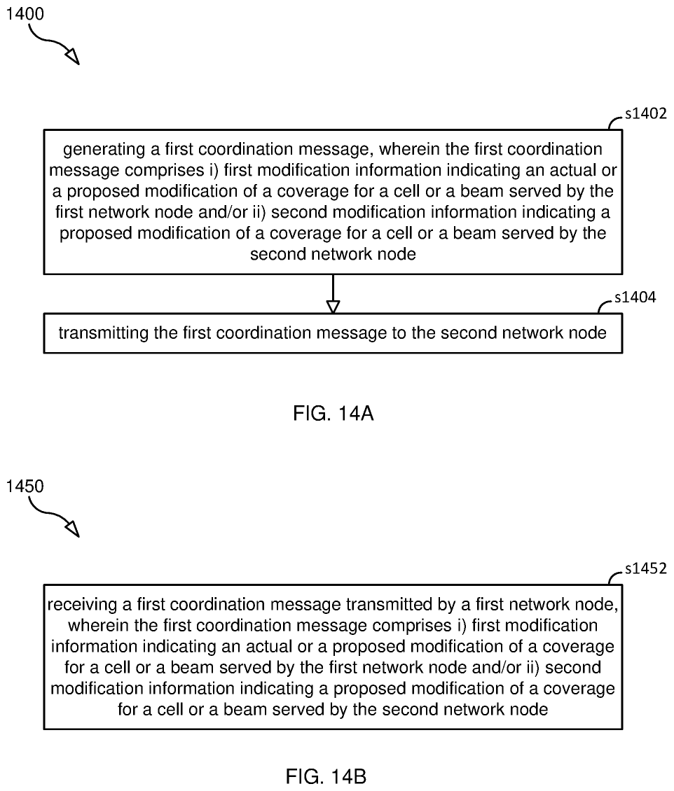

AA1. A method (1400) (see FIG. 14A) performed by a first network node (901) for coordinating with a second network node (902) with respect to an actual or proposed energy saving action, the method comprising: the first network node generating (s1402) a first coordination message, wherein the first coordination message comprises: i) first modification information indicating that an actual modification of a coverage for at least one cell and/or at least one reference signal beam served by the first network node has occurred for an energy savings reason, and/or ii) second modification information indicating a proposed modification of a coverage for at least one cell and/or at least one reference signal beam served by the first network node (e.g., the proposed modification is being proposed for an energy savings reason), and/or iii) third modification information indicating a proposed modification of a coverage for at least one cell and/or at least one reference signal beam served by the second network node (e.g., the proposed modification is being proposed for an energy savings reason); and the first network node transmitting (s1404) the first coordination message to the second network node, wherein if the first coordination message includes the first modification information indicating that an actual modification has occurred, then: i) the actual modification that has occurred is not a deactivation of the cell, and/or ii) the first coordination message further comprise an energy metric associated with the coverage modification indicated by the first modification information, and/or iii) the first coordination message further comprises the second and/or the third modification information.

AA1.1. The method of embodiment AA1, wherein if the first coordination message includes the third modification information, then: i) the first coordination message indicates that a reason for the proposed modification of the coverage is an energy saving reason, and/or ii) the first coordination message further comprises an energy metric associated with the coverage modification indicated by the third modification information, and/or iii) the first coordination message further comprises the first and/or second modification information.

AA1.2. The method of embodiment AA1 or AA1.1, wherein if the first coordination message includes the second modification information, then: i) the first coordination message indicates that a reason for the proposed modification of the coverage is an energy saving reason, or ii) the first coordination message further comprises an energy metric associated with the coverage modification indicated by the second modification information, or iii) the first coordination message further comprises the first and/or third modification information.

AA2. The method of embodiment AA1, AA1.1, or AA1.2, further comprising: prior to generating the first coordination message, the first network node deciding to take an energy savings action (i.e., take an action for an energy savings purpose), wherein the first network node generates and transmits the first coordination message as a result of deciding to take the energy savings action.

AA3. The method of embodiment AA2, wherein the first network node determines the coverage modification of a cell or a reference signal beam served by the second network node in response to deciding to take the energy savings action.

AA4. The method of any one of embodiments AA1-AA3, wherein the reference signal beam served by the first network node or the second network node is a Synchronization Signal Block, SSB, beam or a Channel State Information Reference Signal, CSI-RS, beam.

AA5. The method of any one of embodiments AA1-AA4, wherein first coordination message comprises the first modification information and further comprises an indicator that indicates either: i) that the first coordination message includes the first modification information or ii) that the first coordination message includes the second modification information.

AA6. The method of any one of embodiments AA1-AA5, wherein the coverage modification is one or more of: a partial or complete reduction in a coverage area, a partial or complete restore of a coverage area an expansion of a coverage area, a change in shape of a coverage area, a split of a coverage area a merge of coverage areas an antenna tilt adjustment, a physical layer adjustment, or a change in capacity (e.g., a reduction or an expansion of capacity).

AA6.1. The method of any one of embodiments AA1-AA5, wherein the coverage modification can be obtained in one step or in multiple steps (i.e. gradually).

AA7. The method of any one of embodiments AA1-AA6.1, wherein the first coordination message comprises the third modification information, and the proposed modification indicated by the third modification information is a proposed capacity modification.

AA8. The method of any one of embodiments AA1-AA61.1, wherein the first coordination message comprises the third modification information, and the proposed modification of the coverage indicated by the third modification information is a proposed activation or deactivation of a reference signal beam served by the second network node.

AA9. The method of any one of embodiments AA1-AA8, wherein the first coordination message further includes an energy metric associated with the coverage modification.

AA10. The method of embodiment AA9, wherein the energy metric indicates an amount of energy that is expected to be saved, the energy metric indicates an expected energy efficiency, or the energy metric indicates an expected energy efficiency gain.

AA11. The method of any one of embodiments AA1-AA10, further comprising the first network node receiving a second coordination message transmitted by the second network node, wherein the second coordination message comprises: i) fourth modification information indicating an actual or a proposed modification of a coverage for a cell or a reference signal beam served by the second network node and/or ii) fifth modification information indicating a proposed modification of a coverage of a cell or reference signal beam served by the first network node.

BB1. A method (1450) (see FIG. 14B) performed by a second network node (902) for coordinating with a first network node (901) with respect an actual or proposed energy saving action, the method comprising: the second network node receiving (s1452) a first coordination message transmitted by the first network node, wherein the first coordination message comprises: i) first modification information indicating that an actual modification of a coverage for at least one cell and/or at least one reference signal beam served by the first network node has occurred for an energy savings reason, and/or ii) second modification information indicating a proposed modification of a coverage for at least one cell and/or at least one reference signal beam served by the first network node (e.g., the proposed modification is being proposed for an energy savings reason), and/or iii) third modification information indicating a proposed modification of a coverage for at least one cell and/or at least one reference signal beam served by the second network node (e.g., the proposed modification is being proposed for an energy savings reason), wherein if the first coordination message includes the first modification information indicating that an actual modification has occurred, then: i) the actual modification that has occurred is not a deactivation of the cell, and/or ii) the first coordination message further comprise an energy metric associated with the coverage modification indicated by the first modification information, and/or iii) the first coordination message further comprises the second and/or the third modification information.

BB1.1. The method of embodiment BB1, wherein if the first coordination message includes the third modification information, then: i) the first coordination message indicates that a reason for the proposed modification of the coverage is an energy saving reason, and/or ii) the first coordination message further comprises an energy metric associated with the coverage modification indicated by the third modification information, and/or iii) the first coordination message further comprises the first and/or second modification information.

BB1.2. The method of embodiment BB1 or BB1.1, wherein if the first coordination message includes the second modification information, then: i) the first coordination message indicates that a reason for the proposed modification of the coverage is an energy saving reason, or ii) the first coordination message further comprises an energy metric associated with the coverage modification indicated by the second modification information, or iii) the first coordination message further comprises the first and/or third modification information.

BB2. The method of embodiment BB1, BB1.1, or BB1.2, wherein the first coordination message comprises the third modification information, and the method further comprises the second network node transmitting to the first network node a response message indicating that i) the second network node will implement the proposed coverage modification or ii) the second network node will not implement the proposed modification.

BB3. The method of any one of embodiments BB1-BB2, further comprising the second network node transmitting to the first network node a second coordination message, wherein the second coordination message comprises: i) fourth modification information indicating an actual or a proposed modification of a coverage for a cell or a reference signal beam served by the second network node and/or ii) fifth modification information indicating a proposed modification of a coverage of a cell or reference signal beam served by the first network node.

BB4. The method of any one of embodiments BB1-BB3, wherein the reference signal beam served by the first network node or the second network node is a Synchronization Signal Block, SSB, beam or a Channel State Information Reference Signal, CSI-RS, beam.

BB5. The method of any one of embodiments BB1-BB4, wherein first coordination message further comprises an indicator that indicates either: i) that the first coordination message includes the first modification information or ii) that the first coordination message includes the second modification information.

BB6. The method of any one of embodiments BB1-BB5, wherein the coverage modification is one or more of: a partial or complete reduction in a coverage area, a partial or complete restore of a coverage area, an expansion of a coverage area, a change in shape of a coverage area, a split of a coverage area, a merge of coverage areas, an antenna tilt adjustment, or a physical layer adjustment, or a change in capacity (e.g., a reduction or an expansion of capacity).

BB6a. The method of any one of embodiments BB1-BB5, wherein the coverage modification can be obtained in one step or in multiple steps (i.e. gradually).

BB7. The method of any one of embodiments BB1-BB6, wherein the first coordination message comprises the third modification information, and the proposed modification of the coverage indicated by the third modification information is a proposed capacity configuration modification.

BB8. The method of any one of embodiments BB1-BB6, wherein the first coordination message comprises the third modification information, and the proposed modification of the coverage indicated by the third modification information is a proposed activation or deactivation of a reference signal beam served by the second network node.

BB9. The method of any one of embodiments BB1-BB8, wherein the first coordination message further includes an energy metric associated with the coverage modification.

BB10. The method of embodiment BB9 and the energy metric indicates an amount of energy that is expected to be saved, the energy metric indicates an expected energy efficiency, or the energy metric indicates an expected energy efficiency gain.

BB11. The method of embodiment BB10, further comprising the second network node using the energy metric in a process for deciding whether or not to change a coverage of a cell and/or a reference signal beam served by the second network node.

CC1. A computer program (1543) comprising instructions (1544) which when executed by processing circuitry (1555) of a network node apparatus (1500) causes the network node apparatus to perform the method of any one of embodiments AA1-AA11 or BB1-BB11.

CC2. A carrier containing the computer program of embodiment CC1, wherein the carrier is one of an electronic signal, an optical signal, a radio signal, and a computer readable storage medium (1542).

CC3. A network node apparatus (1500) that is configured to perform the method of any one of embodiments AA1-AA11 or BB1-BB11.

While various embodiments are described herein, it should be understood that they have been presented by way of example only, and not limitation. Thus, the breadth and scope of this disclosure should not be limited by any of the above described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Abbreviations

3GPP 3rd Generation Partnership Project
5GCN 5G Core Network
5GS 5G System
AMF Access and Mobility Management Function
AN Access Network
CN Core Network
CNC Central Network Controller
CP Control Plane
CRS Cell-specific reference signal
CU Central Unit
DC Dual Connectivity
DU Distributed Unit
eNB E-UTRAN NodeB
EN-DC E-UTRA-NR Dual Connectivity
E-UTRA Evolved UTRA
E-UTRAN Evolved UTRAN
GBR Guaranteed Bit Rate
gNB Radio base station in NR
ID Identifier/Identity
IE Information Element
LTE Long Term Evolution
MME Mobility Management Entity
MN Master Node
MR-DC Multi-Radio Dual Connectivity
NE-DC NR-E-UTRA Dual Connectivity
NG Next Generation
NGEN-DC NG-RAN E-UTRA-NR Dual Connectivity
NG-RAN NG Radio Access Network
NR New Radio
OAM/O&M Operation and Maintenance
QCI QoS Class Identifier
QoB Quality of Experience
QOS Quality of Service
RAN Radio Access Network
RAT Radio Access Technology
RRC Radio Resource Control
S1 The interface between the RAN and the CN in LTE.
S1AP S1 Application Protocol
SN Secondary Node
SSB Synchronization Signal/PBCH block
UAI Unified Air Interface
UE User Equipment

1. A method performed by a first network node for coordinating with a second network node with respect to an energy metric, the method comprising:
the first network node determining or identifying based on the energy metric at least one of: (i) an action to perform or (ii) a request relating to the second network node;
the first network node generating a first message, the first message comprising an indication that the action or the request is due to an energy saving reason; and
the first network node transmitting the first message towards the second network node.

2. The method of claim 1, further comprising:
the first network node receiving a second message transmitted by the second network node, the second message comprising a response to the first message.

3. The method of claim 1, wherein
the first network node determines or identifies, based on the energy metric, an action to perform, and
the action to perform comprises one or more of:
an offloading of network traffic to the second network node,
a handover of one or more user equipments (UEs) to the second network node,
an adjustment of one or more mobility parameters,
a reduction of load at the first network node,
a reduction in capacity at the first network node,
an adjustment in a sleep mode state at the first network node,
a reduction of one or more processing resources at the first network node, or
an adjustment to a downlink transmission cycle.

4. The method of claim 1, wherein the indication indicates one or more of the following:
a handover is desired due to the energy saving reason,
network node power saving,
the action is desired because of an energy saving reason,
a cell and/or reference signal beam are or will not be available for energy saving reasons, or a cell and/or reference signal beam deactivation is desired or planned due to energy saving reasons.

5. The method of claim 1, wherein the first message further comprises one or more of:
an indication of an amount of load being transferred from the first network node to the second network node, or
a request for the second network node to update a capacity of at least one cell or reference signal beam of the second network node.

6. The method of claim 1, wherein the first message further comprises one or more of:
an indication of an amount or percentage of load to be offloaded from a cell or reference signal beam of the first network node in order to deactivate the cell or reference signal beam,
an indication of an amount or percentage of load to be offloaded from a cell or reference signal beam of the first network node in order to reach the energy metric,
an amount or percentage of load for a cell or reference signal beam of the first network node for which the energy metric is met,
a cell global identity (CGI) of at least one cell of the first network node to be deactivated based on the energy metric,
a CGI of at least one cell of the first network node for which the energy efficiency metric is to be enhanced,
an indication of an implication of the action or the request on the energy metric, or
a time interval within which the first network node is planning to transfer traffic to the second network node.

7. The method of claim 1, wherein
the first message comprises an indication of an amount of load to be offloaded from the first network node the second network node, and
the indication of the amount of load to be offloaded comprises one or more of:
a total radio resource usage,
a data volume,
a total or average throughput,
a number of radio resource control (RRC) connections,
a number of active user equipments (UEs),
one or more radio conditions of UEs to be offloaded and/or a geographical location,
a served QoS flow,
a total amount of GBR and non GBR resources to be offloaded,
a load information specified on a per network slice basis,
a value corresponding to an energy metric,
a time interval within which the first network node is planning to transfer traffic to the second network node, or
a UE type to be offloaded.

8. (canceled)

9. (canceled)

10. The method of claim 1, wherein
the first message comprises information indicating a policy for the first or second network node relating to the energy metric, and
the policy for the first network node relating to the energy metric comprises one or more of:
a specified mode relating to power consumption,
a preferred energy consumption state,
a preferred load state,
an indication of deactivation or activation of energy saving functionality, or
a margin for acceptable energy consumption increase.

11. (canceled)

12. The method of claim 1, wherein
the first message comprises information indicating one or more validity criteria relating to the energy metric, and
the validity criteria comprises one or more of:
an operator constraint indicating a time period during which load transfer due to energy efficiency is not desirable,
an operator constraint connected to a specific performance indicator,
an operator constraint connected to specific services,
a constraint on a cell or reference signal beam level (e.g. SSB beam level), indicating that at least one cell or at least one reference signal beam (e.g. a SSB beam) shall, should, or cannot be considered for energy saving related decisions,
an activation or deactivation of energy saving function in combination with aspects concerning an air interface transmission/reception that can impact energy consumption of more than one cell or more than one transmission point at same time,
a possibility of coexistence of energy saving opportunities with functionalities concerning duplication of packet transmission/reception to ensure high reliability,
an activation or deactivation of an energy saving function based on QoE related indication, or
an activation or deactivation of energy saving function based on temperature indication.

13. (canceled)

14. The method of claim 1, the method further comprising:
the first network node providing, to a machine learning model, input based on the response to the first message and further comprising an indication of the action or the request; and
the first network node obtaining an output generated by the machine learning model, the output comprising an indication of the impact of the action or the request of a key performance indicator (KPI) metric for a user equipment, wherein
the machine learning model is implemented in the first network node, or
the machine learning model is implemented in a central node, and the providing comprises the first network node transmitting the input towards the central node and the obtaining comprises receiving the output transmitted by the central node.

15. (canceled)

16. (canceled)

17. A first network node in a radio access network configured to:
determine or identify based on an energy metric at least one of: (i) an action to perform or (ii) a request relating to the second network node;
generate a first message, the first message comprising an indication that the action or the request is due to an energy saving reason; and
transmit the first message towards the second network node.

18. (canceled)

19. A non-transitory computer readable storage medium storing a computer program comprising instructions which when executed by processing circuitry of a first network node causes the first network node to perform the method of claim 1.

20. A method performed by a second network node for coordinating with a first network node with respect to an energy metric, the method comprising:
the second network node receiving a first message transmitted by the first network node, the first message comprising a request comprising an indication that an action to be performed or a request relating to the second network node is associated with the energy metric; and
the second network node transmitting a second message towards the first network node, the second message comprising a response to the first message.

21. The method of claim 20, wherein the action to perform comprises:
an offloading of network traffic to the second network node,
a handover of one or more user equipments (UEs) to the second network node,
an adjustment of one or more mobility parameters,
a reduction of load at the first network node,
a reduction in capacity at the first network node,
an adjustment in a sleep mode state at the first network node,
a reduction of one or more processing resources at the first network node, and/or
an adjustment to a downlink transmission cycle.

22. The method of claim 20, wherein the indication indicates one or more of the following:
a handover is desired due to the energy saving reason,
network node power saving,
the action is desired because of an energy saving reason,
a cell and/or reference signal beam are or will not be available for energy saving reasons, or
a cell and/or reference signal beam deactivation is desired or planned due to energy saving reasons.

23. The method of claim 20, wherein the first message further comprises one or more of:
an indication of an amount of load being transferred from the first network node to the second network node, or
a request for the second network node to update a capacity of at least one cell or reference signal beam of the second network node.

24. The method of claim 20, wherein the first message further comprises one or more of:
an indication of an amount or percentage of load to be offloaded from a cell or reference signal beam of the first network node in order to deactivate the cell or reference signal beam,
an indication of an amount or percentage of load to be offloaded from a cell or reference signal beam of the first network node in order to reach the energy metric,
an amount or percentage of load for a cell or reference signal beam of the first network node for which the energy metric is met,
a cell global identity (CGI) of at least one cell of the first network node to be deactivated based on the energy metric,
a CGI of at least one cell of the first network node for which the energy efficiency metric is to be enhanced,
an indication of an implication of the action or the request on the energy metric, or
a time interval within which the first network node is planning to transfer traffic to the second network node.

25. The method of claim 20, wherein the first message comprises an indication of an amount of load to be offloaded from the first network node the second network node.

26-35. (canceled)

36. A second network node in a radio access network configured to:
receive a first message transmitted by the first network node, the first message comprising a request comprising an indication that an action to be performed or a request relating to the second network node is associated with an energy metric; and
transmit a second message towards the first network node, the second message comprising a response to the first message.

37. (canceled)

38. A non-transitory computer readable storage medium storing a computer program comprising instructions which when executed by processing circuitry of a second network node causes the second network node to perform the method of claim 20.
